(19) United States
(12) Patent Application Publication
(10) Pub. No.: US 2014/0060997 A1
(43) Pub. Date: Mar. 6, 2014

(54) MONEY HANDLING SYSTEM, MONEY SETTLEMENT APPARATUS, MONEY TELLER APPARATUS AND MONEY HANDLING METHOD

(71) Applicants: Kazuhiro Doi, Himeji-shi (JP); Minoru Higashiyama, Himeji-shi (JP); Masatsugu Yokotani, Himeji-shi (JP)

(72) Inventors: Kazuhiro Doi, Himeji-shi (JP); Minoru Higashiyama, Himeji-shi (JP); Masatsugu Yokotani, Himeji-shi (JP)

(73) Assignee: GLORY LTD., Himeji-shi, Hyogo-ken (JP)

(21) Appl. No.: 14/000,676

(22) PCT Filed: Feb. 22, 2011
(86) PCT No.: PCT/JP2011/053777

§ 371 Date: Nov. 23, 2013

(51) Int. Cl. G07D 11/00

(52) U.S. Cl. CPC G07D 11/0066
USPC 194/206

(57) ABSTRACT

A cash handling system includes: a cash settlement apparatus 11 configured to perform a settlement process with respect to a customer, by depositing and dispensing cash; a cash accounting apparatus 21 configured to dispense cash to be loaded to the cash settlement apparatus and configured to deposit cash having been collected from the cash settlement apparatus; and a cash transport cassette 30 attachable to and detachable from the cash settlement apparatus and the cash accounting apparatus, the cash transport cassette configured to pass cash to and from the cash settlement apparatus or the cash accounting apparatus when the cash transport cassette is attached to the cash settlement apparatus or the cash accounting apparatus, and configured to store cash such that the cash therein is incapable of being taken out when the cash transport cassette is detached from the cash settlement apparatus and the cash accounting apparatus.

### TECHNICAL FIELD

The present invention relates to a cash handling system, a cash settlement apparatus, a cash accounting apparatus and a method for handling cash. For example, the present invention relates to a cash handling system, a cash settlement apparatus, a cash accounting apparatus and a method for handling cash capable of handing over cash and storing the cash in a settlement process in a store.

### BACKGROUND ART

In a checkout counter of a store, a cash settlement apparatus and a POS (Point of Sale) register have been conventionally used, in order that cash is handed over between a clerk and a customer. The cash settlement apparatus has a function for recognizing and counting cash having been put thereinto to calculate a sum thereof, a function for storing the cash, and a function for dispensing the cash stored therein as change.

On the other hand, in a back office of a store, a cash accounting apparatus is used for loading cash such as a change fund and the like to a cash settlement apparatus installed in the store with, or for collecting sales proceeds and the like from the cash settlement apparatus. The cash accounting apparatus has a function for storing cash having been collected from the cash settlement apparatus, and a function for dispensing cash to be loaded to the cash settlement apparatus.
Patent Document 1: EP2031567
Patent Document 2: EP1735757
Patent Document 3: U.S. Pat. No. 5,830,054
Patent Document 4: EP2062230

### SUMMARY OF THE INVENTION

Upon start of store hours, a clerk is generally required to load a change fund and the like to the cash settlement apparatus with. In addition, after the store hours, a clerk is required to store sales proceeds and the like stored in the cash settlement apparatus into the cash accounting apparatus in the back office.

In such a change loading process and a change collecting process, it is undesirable that a clerk manually moves cash in terms of security. When a clerk operates under administration of a manager in consideration of security, the manager is needed in addition to the clerk in order for monitoring and authorizing the operation, which is troublesome.

In order to solve the aforementioned problem, a cash handling system according to the present invention includes: a cash settlement apparatus configured to perform a settlement process with respect to a customer, by depositing and dispensing cash; a cash accounting apparatus configured to dispense cash to be loaded to the cash settlement apparatus, and configured to deposit cash having been collected from the cash settlement apparatus; and a cash transport cassette attachable to and detachable from the cash settlement apparatus and the cash accounting apparatus, the cash transport cassette configured to pass cash to and from the cash settlement apparatus or the cash accounting apparatus when the cash transport cassette is attached to the cash settlement apparatus or the cash accounting apparatus, and configured to store cash such that the cash therein is incapable of being taken out when the cash transport cassette is detached from the cash settlement apparatus and the cash accounting apparatus.

The cash settlement apparatus may include a coin settlement apparatus configured to perform the settlement process by depositing and dispensing a coin, and a banknote settlement apparatus configured to perform the settlement process by depositing and dispensing a banknote, and the cash accounting apparatus may include a coin accounting apparatus configured to dispense a coin to be loaded to the coin settlement apparatus and configured to deposit a coin having been collected from the coin settlement apparatus, and a banknote accounting apparatus configured to dispense a banknote to be loaded to the banknote settlement apparatus and configured to deposit a banknote having been collected from the banknote settlement apparatus.

The cash transport cassette may include at least one of a coin transport cassette configured to pass a coin to and from the coin settlement apparatus or the coin accounting apparatus when the coin transport cassette is attached to the coin settlement apparatus or the coin accounting apparatus, and a banknote transport cassette configured to pass a banknote to and from the banknote settlement apparatus or the banknote accounting apparatus when the banknote transport cassette is attached to the banknote settlement apparatus or the banknote accounting apparatus.

The cash accounting apparatus may include a depositing unit configured to deposit cash without using the cash transport cassette, and a dispensing unit configured to dispense cash without using the cash transport cassette.

The cash handling system may further a storing drawer configured to store cash that is passed in the settlement process, wherein the coin accounting apparatus includes a coin depositing unit configured to deposit a coin from the storing drawer for collection, a storing-drawer attaching unit to which the storing drawer is attachable, and a coin dispensing unit configured to dispense a coin in order to load the coin to the storing drawer attached to the storing-drawer attaching unit, after the coin has been sorted by denomination.

The cash transport cassette may include a memory unit configured to store at least cassette ID information for specifying the cash transport cassette.

The memory unit may be configured to store denomination information of cash stored in the cash transport cassette and amount information thereof.

The cash transport cassette may include a tape reeling-type storing unit, in which respective banknotes sandwiched between a pair of elongate tapes are reeled up together with the tapes; and the memory unit may be configured to store denominations of the banknotes in the tape reeling-type storing unit in a reeled order.

The cash settlement apparatus or the cash accounting apparatus may be configured to store, by denomination, the banknotes from the cash transport cassette in accordance with the reeled order stored in the memory unit.

The cash handling system may further include a management apparatus communicably connected to the cash settlement apparatus and the cash accounting apparatus, the management apparatus configured to manage cash having been subjected to the settlement process in the cash settlement apparatus and cash having been passed between the cash settlement apparatus and the cash accounting apparatus.

The management apparatus may be capable of setting a denomination of cash to be collected from the cash settlement apparatus to the cash transport cassette.

A cash settlement apparatus in this embodiment of the present invention is a cash settlement apparatus configured to perform a settlement process with respect to a customer, by depositing and dispensing cash, the cash settlement apparatus including: a transport unit configured to transport cash to be deposited or dispensed; a storing unit configured to store cash having been transported by the transport unit; and an attaching unit to which a cash transport cassette is attachable and from which the cash transport cassette is detachable, the cash transport cassette configured to pass cash to and from the cash settlement apparatus when the cash transport cassette is attached to the cash settlement apparatus, and configured to store cash such that the cash therein is incapable of being taken out when the cash transport cassette is detached from the cash settlement apparatus; wherein when the cash transport cassette is attached to the attaching unit, the cash settlement apparatus is configured to deposit cash in the cash transport cassette to the storing unit for loading, and configured to dispense cash from the storing unit to the cash transport cassette for collection.

The cash settlement apparatus may further include: a coin settlement apparatus configured to perform the settlement process by depositing and dispensing a coin; and a banknote settlement apparatus configured to perform the settlement process by depositing and dispensing a banknote.

The cash settlement apparatus may further include a reading/writing unit configured to read out cassette ID information from a memory unit disposed on the cash transport cassette and configured to store at least the cassette ID information for specifying the cash transport cassette; wherein: the memory unit is configured to store denomination information of cash stored in the cash transport cassette and amount information thereof; and the reading/writing unit is configured to read out the denomination information and the amount information from the memory unit, or configured to write the denomination information and the amount information to the memory unit.

A cash accounting apparatus in an embodiment of the present invention is a cash accounting apparatus communicably connected to a cash settlement apparatus configured to perform a settlement process with respect to a customer by depositing and dispensing cash, the cash accounting apparatus configured to dispense cash to be loaded to the cash settlement apparatus and configured to deposit cash having been collected from the cash settlement apparatus, the cash accounting apparatus including: a transport unit configured to transport cash to be deposited or dispensed; a storing unit configured to store cash having been transported by the transport unit; and an attaching unit to which a cash transport cassette is attachable and from which the cash transport cassette is detachable, the cash transport cassette configured to pass cash to and from the cash accounting apparatus when the cash transport cassette is attached to the cash accounting apparatus, and configured to store cash such that the cash therein is incapable of being taken out when the cash transport cassette is detached from the cash accounting apparatus; wherein when the cash transport cassette is attached to the attaching unit, the cash accounting apparatus is configured to dispense cash to the cash transport cassette for loading the cash to the cash settlement apparatus, or configured to deposit cash from the cash transport cassette for collecting cash from the cash settlement apparatus.

The cash accounting apparatus may include a coin accounting apparatus configured to dispense a coin to be loaded to a coin settlement apparatus and configured to deposit a coin having been collected from the coin settlement apparatus, and a banknote accounting apparatus configured to dispense a banknote to be loaded to a banknote settlement apparatus and configured to deposit a banknote having been collected from the banknote settlement apparatus.

The cash accounting apparatus may further include a depositing unit configured to deposit cash without using the cash transport cassette, and a dispensing unit configured to dispense cash without using the cash transport cassette, wherein the cash settlement apparatus includes a storing drawer configured to store cash that is passed in the settlement process, and the coin accounting apparatus further includes a coin depositing unit configured to deposit a coin from the storing drawer for collection, and a coin dispensing unit configured to dispense a coin for loading the coin to the storing drawer.

A method for handling cash in an embodiment of the present invention is a method for handling cash between a cash settlement apparatus and a cash accounting apparatus, the cash settlement apparatus configured to perform a settlement process with respect to a customer by depositing and dispensing cash, and the cash accounting apparatus configured to dispense cash to be loaded to the cash settlement apparatus and configured to deposit cash having been collected from the cash settlement apparatus, the method including: in a case where cash is loaded from the cash accounting apparatus to the cash settlement apparatus, attaching a cash transport cassette to the cash accounting apparatus, the cash transport cassette being attachable to and detachable from the cash settlement apparatus and the cash accounting apparatus; dispensing cash to the cash transport cassette from the cash accounting apparatus; after having detached the cash transport cassette from the cash accounting apparatus and having attached the cash transport cassette to the cash settlement apparatus, depositing the cash to the cash settlement apparatus from the cash transport cassette; and in a case where cash is collected from the cash settlement apparatus to the cash accounting apparatus, attaching the cash transport cassette on the cash settlement apparatus, dispensing cash from the cash settlement apparatus to the cash transport cassette, and after having detached the cash transport cassette from the cash settlement apparatus and having attached the cash transport cassette to the cash accounting apparatus, depositing the cash to the cash accounting apparatus from the cash transport cassette.

The cash settlement apparatus may include a coin settlement apparatus configured to perform the settlement process by depositing and dispensing a coin, and a banknote settlement apparatus configured to perform the settlement process by depositing and dispensing a banknote; the cash accounting apparatus may include a coin accounting apparatus configured to dispense a coin to be loaded to the coin settlement apparatus and configured to deposit a coin having been collected from the coin settlement apparatus, and a banknote accounting apparatus configured to dispense a banknote to be loaded to the banknote settlement apparatus and configured to deposit a banknote having been collected from the banknote settlement apparatus; when the cash transport cassette is attached to the coin settlement apparatus or the coin accounting apparatus, the cash transport cassette may be configured to pass a coin to and from the coin settlement apparatus or the coin accounting apparatus; and when the cash transport cassette is attached to the banknote settlement apparatus or the banknote accounting apparatus, the cash transport cassette may be configured to pass a banknote to and from the banknote settlement apparatus or the banknote accounting apparatus.

The cash transport cassette may include a memory unit configured to store at least cassette ID information for specifying the cash transport cassette; in a case where cash is loaded from the cash accounting apparatus to the cash settlement apparatus, reading out the cassette ID information by the cash accounting apparatus while the cash transport cassette is attached to the cash accounting apparatus, and transmitting the cassette ID information to the cash settlement apparatus, reading out the cassette ID information from the memory unit by the cash settlement apparatus, when the cash transport cassette is attached to the cash settlement apparatus, and depositing cash from the cash transport cassette to the cash settlement apparatus, when the cassette ID information having been read out from the memory unit and the cassette ID information having been transmitted from the cash accounting apparatus conform to each other; and in a case where cash is collected from the cash settlement apparatus to the cash accounting apparatus, reading out the cassette ID information by the cash settlement apparatus while the cash transport cassette is attached to the cash settlement apparatus, and transmitting the cassette ID information to the cash accounting apparatus, reading out the cassette ID information from the memory unit by the cash accounting apparatus, when the cash transport cassette is attached to the cash accounting apparatus, and depositing cash from the cash transport cassette to the cash accounting apparatus, when the cassette ID information having been read out from the memory unit and the cassette ID information having been transmitted from the cash settlement apparatus conform to each other.

The memory unit may store denomination information of cash stored in the cash transport cassette and amount information thereof; in a case where cash is loaded from the cash accounting apparatus to the cash settlement apparatus, transmitting the denomination information and the amount information, together with the cassette ID information, from the cash accounting apparatus to the cash settlement apparatus, depositing cash from the cash transport cassette to the cash settlement apparatus, when the cassette ID information having been read out from the memory unit and the cassette ID information having been transmitted from cash accounting apparatus conform to each other, counting the deposited cash by denomination in the cash settlement apparatus, and loading the cash to the cash settlement apparatus, when the denomination and the amount of the deposited cash respectively conform to the denomination information and the amount information; and in a case where cash is collected from the cash settlement apparatus to the cash accounting apparatus, transmitting the denomination information and the amount information, together with the cassette ID information, from the cash settlement apparatus to the cash accounting apparatus, depositing cash from the cash transport cassette to the cash accounting apparatus, when the cassette ID information having been read out from the memory unit and the cassette ID information having been transmitted from the cash settlement apparatus conform to each other, counting the deposited cash by denomination in the cash accounting apparatus, and collecting the cash to the cash accounting apparatus, when the denomination and the amount of the deposited cash respectively conform to the denomination information and the amount information.

The cash handling system, the cash settlement apparatus, the cash accounting apparatus and the method for handling cash according to the present invention are safe in terms of security, can save user's labor, and can precisely perform a change loading process or a sales-proceeds collecting process.

### BRIEF DESCRIPTION OF THE DRAWINGS

FIG. 1 is a block diagram showing a structural example of a cash management system 1 in an embodiment according to the present invention.

FIG. 2 is an outline view showing an example of each cash settlement apparatus 11.

FIG. 3 is a block diagram showing a structural example of the cash settlement apparatus 11.

FIG. 4 is a sectional view showing an example of an inside structure of a banknote settlement apparatus 12 of the cash settlement apparatus 11.

FIG. 5 is a sectional view showing an inside structure of a coin settlement apparatus 13 of the cash settlement apparatus 11.

FIG. 6 is an outline view showing an example of a cash accounting apparatus 21.

FIG. 7 is a block diagram showing a structural example of the cash accounting apparatus 21.

FIG. 8 is a sectional view showing an example of an inside structure of a banknote accounting apparatus 22 of the cash accounting apparatus 21.

FIG. 9 is a sectional view showing an example of an inside structure of a coin accounting apparatus 23 of the cash accounting apparatus 21.

FIG. 10 is an outline view showing a structural example of a cash transport cassette 30 for transporting coins.

FIG. 11 is a flowchart showing an operation of a settlement process in the cash handling system 1 in this embodiment.

FIG. 12 is a flowchart showing an operation of a loading process in the cash handling system 1 in this embodiment.

FIG. 13 is a flowchart showing an operation of a collecting process in the cash handling system 1 in this embodiment.

FIG. 14 is a sectional view showing an inside structure of the coin settlement apparatus 13 in an alternative example of this embodiment.

### DETAILED DESCRIPTION

An embodiment according to the present invention will be described herebelow with reference to the drawings. This embodiment does not limit the present invention.

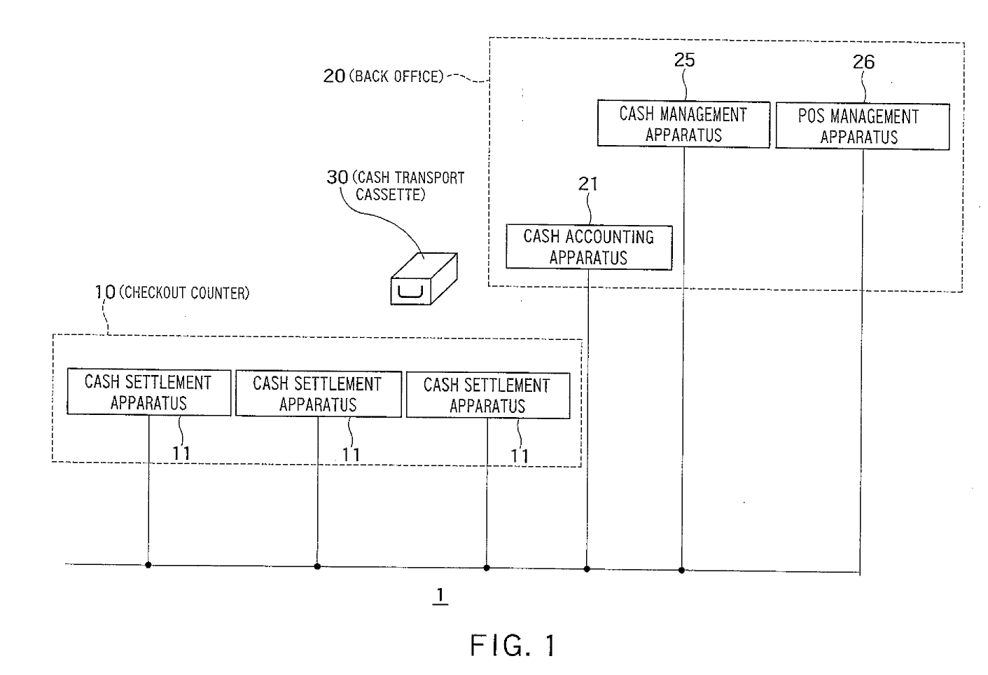

FIG. 1 is a block diagram showing a structural example of a cash management system 1 in an embodiment according to the present invention. The cash management system 1 is a system configured to handle and manage cash received by a clerk from a customer and cash to be paid by the clerk to the customer.

The cash management system 1 is installed in an checkout area in a store. The cash management system 1 is composed of a checkout counter 10 configured to deposit and dispense cash handed over between a clerk and a customer, a back office 20 configured to manage cash in the checkout counter 10 and commercial products, and a cash transport cassette 30 configured to transport cash between the checkout counter 10 and the back office 20.

The checkout counter 10 is provided with one or more cash settlement apparatuses 11 configured to perform a settlement process with respect to a customer, by depositing and dispensing cash. In FIG. 1, the checkout counter 10 is provided with the three cash settlement apparatus. 11. Each cash settlement apparatus 11 is operated by a clerk or a customer himself/herself so as to be used in a settlement process between the clerk and the customer. For example, the cash settlement apparatus 11 deposits payment paid by a customer, and dispenses change to be paid to the customer.

The cash settlement apparatus 11 is communicably connected to a POS register operated by a clerk or a self-checkout register operated by a customer, for example. The cash settlement apparatus 11 may be integrally formed with the POS register or the self-checkout register.

The back office 20 is provided with a cash accounting apparatus 21, a cash management apparatus 25 and a POS management apparatus 26. The cash accounting apparatus 21 is communicably connected to the cash settlement apparatuses 11, and is configured to dispense a change fund to be loaded to the cash settlement apparatuses 11, and configured to deposit sales proceeds having been collected from the cash settlement apparatuses 11. The cash management apparatus 25 is communicably connected to the cash settlement apparatuses 11 and the cash accounting apparatus 21 through a LAN (Local Area Network) or the like. The cash management apparatus 25 is configured to manage cash stored in the cash settlement apparatuses 11 and the cash accounting apparatus 21. For example, the cash management apparatus 25 is configured to manage cash having been settled in the respective cash settlement apparatuses 11, and cash having been passed between each cash settlement apparatus 11 and the cash accounting apparatus 21. In addition, the cash management apparatus 25 may monitor whether the cash transport cassette 30 is attached or not to the cash settlement apparatus 11 or the cash accounting apparatus 21. The POS management apparatus 26 is configured to manage a flow of commercial products. Since the flow of commercial products is not directly related to the present invention, detailed description of the POS management apparatus 26 is omitted.

The cash transport cassette 30 is configured to be attachable to and detachable from the cash settlement apparatus 11 and the cash accounting apparatus 21. When the cash transport cassette 30 is attached to the cash settlement apparatus 11 or the cash accounting apparatus 21, the cash transport cassette 30 can pass cash between the cash transport cassette 30 and the cash settlement apparatus 11, or pass cash between the cash transport cassette 30 and the cash accounting apparatus 21. On the other hand, when the cash transport cassette 30 is detached from the cash settlement apparatus 11 and the cash accounting apparatus 21, the cash transport cassette 30 is configured to store cash therein such that the cash cannot be taken out therefrom. A clerk uses the cash transport cassette 30 to transport cash between the cash settlement apparatus 11 and the cash accounting apparatus 21. For example, when a change fund is loaded or when sales proceeds are collected, a clerk uses the cash transport cassette 30 to transport cash between the cash settlement apparatus 11 and the cash accounting apparatus 21. Since the clerk cannot touch the cash in the cash transport cassette 30 during the cash transportation, the cash can be safely transported in terms of security.

The cash transport cassette 30 may be configured to transport any one of a banknote and a coin, or may be configured to transport both a banknote and a coin. The cash transport cassette 30 for banknote may be a stacking-type cassette in which banknotes are stacked on one another, or may be a tape reeling-type cassette in which banknotes, which are sandwiched one by one between a pair of elongate tapes, are reeled up together with the tapes. The cash transport cassette 30 for coin may be a cassette configured to store coin in a denomination mixed state.

(Structure of Cash Settlement Apparatus 11)

Each of the cash settlement apparatuses 11 includes a coin settlement apparatus 13 configured to perform a settlement process by depositing and dispensing a coin, and a banknote settlement apparatus 12 configured to perform a settlement process by depositing and dispensing a banknote.

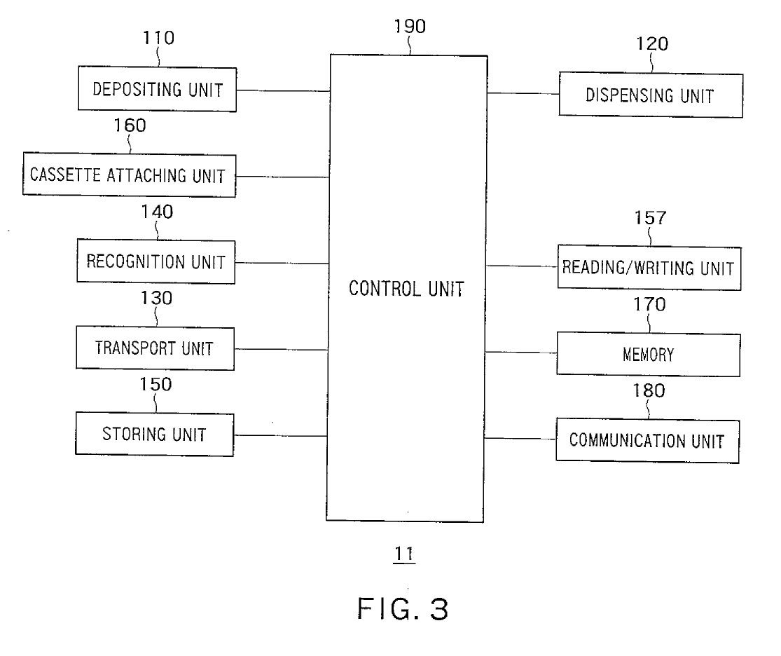

Herebelow, in order to differentiate constituent elements of the banknote settlement apparatus 12 and constituent elements of the coin settlement apparatus 13 from each other, a character “a” is added to a reference number of a constituent element of the banknote settlement apparatus 12, and a character “b” is added to a reference number of a constituent element of the coin settlement apparatus 13. Since the objects (a coin and a banknote) to be handled by the coin settlement apparatus 13 and the banknote settlement apparatus 12 differ from each other, the coin settlement apparatus 13 and the banknote settlement apparatus 12 differ from each other in concrete structures thereof. However, the basic block structure shown in FIG. 3 is common thereto.

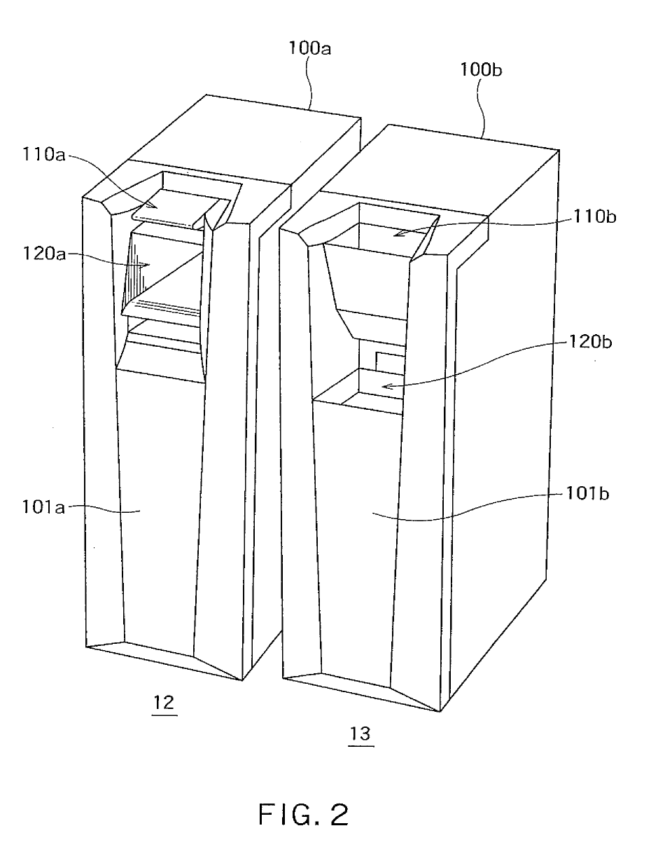

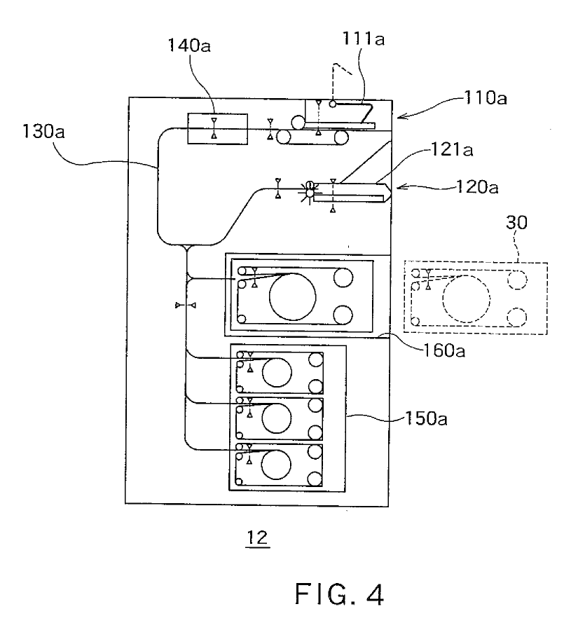

FIG. 2 is a view showing an appearance of an example of each cash settlement apparatus 11. The cash settlement apparatus 11 includes the banknote settlement apparatus 12 and the coin settlement apparatus 13. The banknote settlement apparatus 12 has a housing 100a, a depositing unit 110a and a dispensing unit 120a. The depositing unit 110a is provided for putting a banknote(s) having been received by a customer thereinto. The dispensing unit 120b is provided for dispensing a change banknote(s). When a front cover 101a of the housing 100a is opened, there is a cassette attaching unit (see 160a of FIG. 4) to which the cash transport cassette 30 is attached.

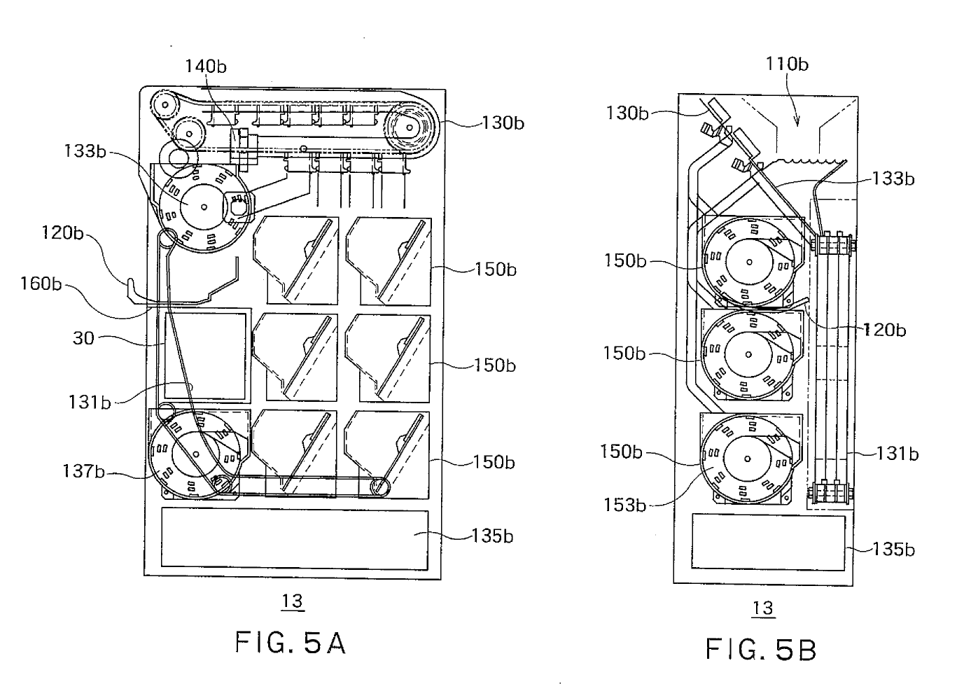

The coin settlement apparatus 13 has a housing 100b, a depositing unit 110b and a dispensing unit 120b. The depositing unit 110b is provided for putting a coin(s) having been received by a customer thereinto. The dispensing unit 120b is provided for dispensing a change coin(s). When a front cover 101b of the housing 100b is opened, there is a cassette attaching unit (see 160b in FIG. 5) to which the cash transport cassette 30 is attached.

FIG. 3 is a block diagram showing a structural example of the cash settlement apparatus 11. In addition to the depositing unit 110 and the dispensing unit 120, the cash settlement apparatus 11 further includes a transport unit 130, a recognition unit 140, a storing unit 150, a reading/writing unit 157, a cassette attaching unit 160, a memory 170, a communication unit 180 and a control unit 190.

The transport unit 130 is configured to transport cash having been put into the depositing unit 110 to the storing unit 150, or configured to transport cash to be dispensed from the dispensing unit 120, from the storing unit 150. In addition, the transport unit 130 is configured to transport cash in the cash transport cassette 30, which is attached to the cassette attaching unit 160, to the storing unit 150, in order that the cash is loaded to the storing unit 150, or configured to transport cash stored in the storing unit 150 to the cash transport cassette 30, in order that the cash is collected from the storing unit 150.

The recognition unit 140 is configured to detect a denomination, an authenticity, a fitness, a version, an amount and so on of cash being transported by the transport unit 130. For example, the recognition unit 140 has a sensor such as an image sensor or a magnetic sensor.

The storing unit 150 is configured to store, by denomination, cash having been recognized by the recognition unit 140. When the storing unit 150 is configured to store banknotes, the storing unit 150 may be stacking-type storing units in which banknotes are stacked on one another by denomination, or may be a plurality of tape reeling-type storing units in which banknotes, which are sandwiched by denomination between a pair of elongate tapes, are reeled up together with the tapes.

The cassette attaching unit 160 is configured such that the cash transport cassette 30 can be attached thereto and detached therefrom. The cassette attaching unit 160 is configured to deposit cash from the cash transport cassette 30 or configured to dispense cash to the cash transport cassette 30.

The reading/wiring unit 157 is configured to read out information stored in a below-described memory unit 35 disposed on the cash transport cassette 30, or configured to write information to the memory unit 35.

The memory 170 includes various programs for controlling the cash settlement apparatus 11, a ROM (Read Only Memory) or a HDD (Hard Disk Drive) storing data, and a RAM (Random Access Memory) serving as a program loading area or a working area when a program is executed, and so on. The memory 170 also stores information (a denomination, an amount and so on) of cash stored in the storing unit 150 and the cash transport cassette 30. Further, the memory 170 may store, by denomination, an amount of cash having been recognized by the recognition unit 140.

The communication unit 180 is communicably connected to other apparatuses (the cash accounting apparatus 21, the cash management apparatus 25, the POS management apparatus 26) constituting the cash handling system 1.

The control unit 190 is a processing unit configured to execute a program in the memory 170 to control the cash settlement apparatus 11 as a whole.

FIG. 4 is a sectional view showing an example of an inside structure of the banknote settlement apparatus 12 of the cash settlement apparatus 11. The banknote settlement apparatus 12 includes a depositing-unit cover 111a. When a banknote(s) is deposited, a clerk opens the depositing-unit cover 111a and puts a banknote(s) into the depositing unit 110a. The depositing unit 110a is configured to feed the banknotes having been put thereinto, one by one, to the transport unit 130a. The transport unit 130a is configured to cause the fed banknotes to pass through the recognition unit 140a, and then configured to transport the banknotes to the storing unit 150a, the cash transport cassette 30 or the dispensing unit 120a. The recognition unit 140a is configured to recognize a denomination, an authenticity, a fitness, a version, an amount and so on of each of the banknotes being transported. The transport unit 130a is configured to store banknotes by denomination into the storing unit 150a, based on the recognition result by the recognition unit 140a.

When the storing unit 150a is full and so on, the transport unit 130a may transport a banknote to the cash transport cassette 30 as needed. In addition, when a banknote could not be recognized by the recognition unit 140a or when a banknote was recognized as a counterfeit note, the transport unit 130a is configured to transport the banknote to the dispensing unit 120a.

On the other hand, in order to dispense a banknote(s), the storing unit 150a is configured to feed banknotes, one by one, to the transport unit 130a. The transport unit 130a transports the fed banknotes to the dispensing unit 120a. The banknote settlement apparatus 12 is provided with a dispensing-unit shutter 121a. When a banknote is dispensed, the banknote settlement apparatus 12 opens the dispensing-unit shutter 121a and dispenses a banknote.

In this manner, the banknote settlement apparatus 12 can store a banknote having been put into the depositing unit 110a, into the storing unit 150a, and can reversely dispense a banknote having been stored into the storing unit 150a to the dispensing unit 120a. That is to say, the banknote settlement apparatus 12 is configured to reuse a banknote having been deposited thereinto, as a banknote to be dispensed.

When the cash transport cassette 30 is attached to the cassette attaching unit 160a, the banknote settlement apparatus 12 can load a banknote from the cash transport cassette 30 to the storing unit 150, or can collect a banknote from the storing unit 150a to the cash transport cassette 30. When a banknote(s) is loaded, the cash transport cassette 30 feeds banknotes, one by one, to the transport unit 130a. The transport unit 130a loads fed banknotes to the storing unit 150a. When a banknote(s) is collected, the storing unit 150a feeds banknotes, one by one, to the transport unit 130a. The transport unit 130a collects the fed banknotes to the cash transport cassette 30.

In this manner, the banknote settlement apparatus 12 is configured to load and collect a banknote(s) with the use of the cash transport cassette 30.

FIGS. 5A and 5B are sectional views showing an example of an inside structure of the coin settlement apparatus 13 of the cash settlement apparatus 11. FIG. 5A is the sectional view of the coin settlement apparatus 13 when viewed from a lateral side, and FIG. 5B is the sectional view of the coin settlement apparatus when viewed from a front side. In FIG. 5B, illustration of the cash transport cassette 30 and the feeding unit 137b is omitted, but the storing units 150b are illustrated.

As shown in FIG. 5B, the coin settlement apparatus 13 includes the depositing unit 110b. When a coin(s) is deposited, a clerk puts a coin(s) into the depositing unit 110b. At this time, a plurality of coins may be put thereinto in a denomination mixed state. A centrifugal disk-type feeding unit 133b is configured to feed, one by one, coins having been put into the depositing unit 110b, to the transport unit 130b. The transport unit 130b is configured to cause the fed coins to pass through the recognition unit 140b, and then configured to transport the coins to the storing unit 150b, the cash transport cassette 30 or the dispensing unit 120b. The recognition unit 140b is configured to recognize a denomination, an authenticity, a fitness, a version, an amount and so on of each of the coins being transported. The transport unit 130b is configured to sort the coins by denomination based on the recognition result by the recognition unit 140b, and configured to store a coin into the storing unit 150b of a corresponding denomination.

When the storing unit 150b is full and so on, the transport unit 130b may transport a coin to the cash transport cassette 30 or the collection box 135b as needed. When a coin was recognized as a reject coin by the recognition unit 140b, the transport unit 130b is configured to dispense the reject coin to the dispensing unit 120b.

On the other hand, in order to dispense a coin(s), the storing unit 150b is configured to feed coins, one by one, to the transport unit 131b. The plurality of storing units 150b is configured to store money by denomination. Each of the storing units 150 has a centrifugal disk-type feeding unit 153b. The feeding unit 153b is configured to feed coins, one by one, to the transport unit 130b. The transport unit 130b is configured to transport the fed coins to the dispensing unit 120b. Thus, the coin settlement apparatus 13 dispenses the coins to the dispensing unit 120b.

In this manner, the coin settlement apparatus 13 can store a coin having been put into the depositing unit 110b, into the storing unit 150b, and can reversely dispense a coin having been stored into the storing unit 150b to the dispensing unit 120b. That is to say, the coin settlement apparatus 13 is configured to reuse a coin having been deposited thereinto, as a coin to be dispensed.

When the cash transport cassette 30 is attached to the cassette attaching unit 160b, the coin settlement apparatus 13 can load a coin from the cash transport cassette 30 to the storing unit 150b, or collect a coin from the storing unit 150b to the cash transport cassette 30. When a coin(s) is loaded, the cash transport cassette 30 dispenses a coin(s) to the feeding unit 137b shown in FIG. 5A. At this time, the cash transport cassette 30 may dispense the coins in a denomination mixed state to the feeding unit 137b. The feeding unit 137b feeds the coins to the transport unit 131b. The transport unit 131b transports the fed coins to the feeding unit 133b, and the feeding unit 133b feeds the coins, one by one, to the transport unit 130b. The transport unit 130b is configured to cause the fed coins to pass through the recognition unit 140b, and then configured to transport the coins to the storing unit 150b or the dispensing unit 120b. The recognition unit 140b is configured to recognize a denomination of each of the coins being transported. The transport unit 130b is configured to store the coins by denomination to the storing units 150b, based on the recognition result by the recognition unit 140b.

When a coin(s) is collected, the coin settlement apparatus 13 is configured to feed coins, one by one, from the storing unit 150b to the transport unit 131b. The transport unit 131b is configured to collect the fed coins to the cash transport cassette 30.

In this manner, the coin settlement apparatus 13 is configured to load and collect a coin(s) with the use of the cash transport cassette 30.

(Structure of Cash Accounting Apparatus 21)

The cash accounting apparatus 21 includes a coin accounting apparatus 23 and a banknote accounting apparatus 22. The coin accounting apparatus 23 is configured to dispense a coin to be loaded to the coin settlement apparatus 13, and configured to deposit a coin having been collected from the coin settlement apparatus 13. The banknote accounting apparatus 22 is configured to dispense a banknote to be loaded to the banknote settlement apparatus 12, and configured to deposit a banknote having been collected from the banknote settlement apparatus 12. A pair of the banknote accounting apparatus 22 and the coin accounting apparatus 23 constitute the cash accounting apparatus 22.

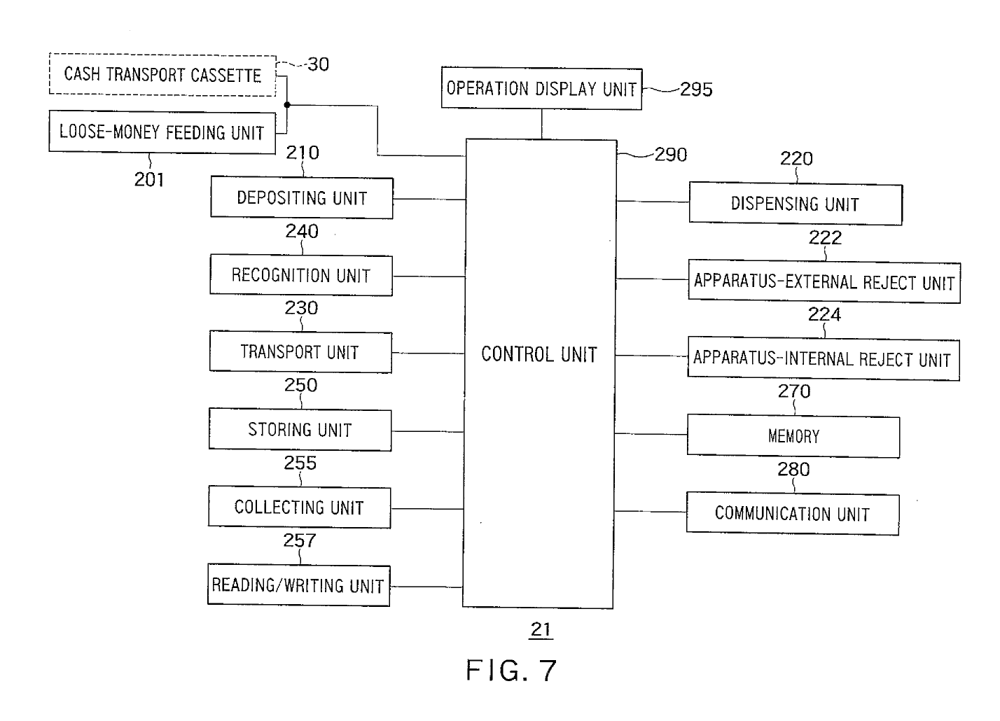

Herebelow, in order to differentiate constituent elements of the banknote accounting apparatus 22 and constituent elements of the coin accounting apparatus 23 from each other, a character “a” is added to a reference number of a constituent element of the banknote accounting apparatus 22, and a character “b” is added to a reference number of a constituent element of the coin accounting apparatus 23. Since the objects (a banknote and a coin) to be handled by the banknote accounting apparatus 22 and the coin accounting apparatus 23 differ from each other, the banknote accounting apparatus 22 and the coin accounting apparatus 23 differ from each other in concrete structures thereof. However, the basic block structure shown in FIG. 7 is common thereto. Note that, an operation display unit 295 is disposed any one of the banknote accounting apparatus 22 and the coin accounting apparatus 23, and is used in common to display information of both apparatuses.

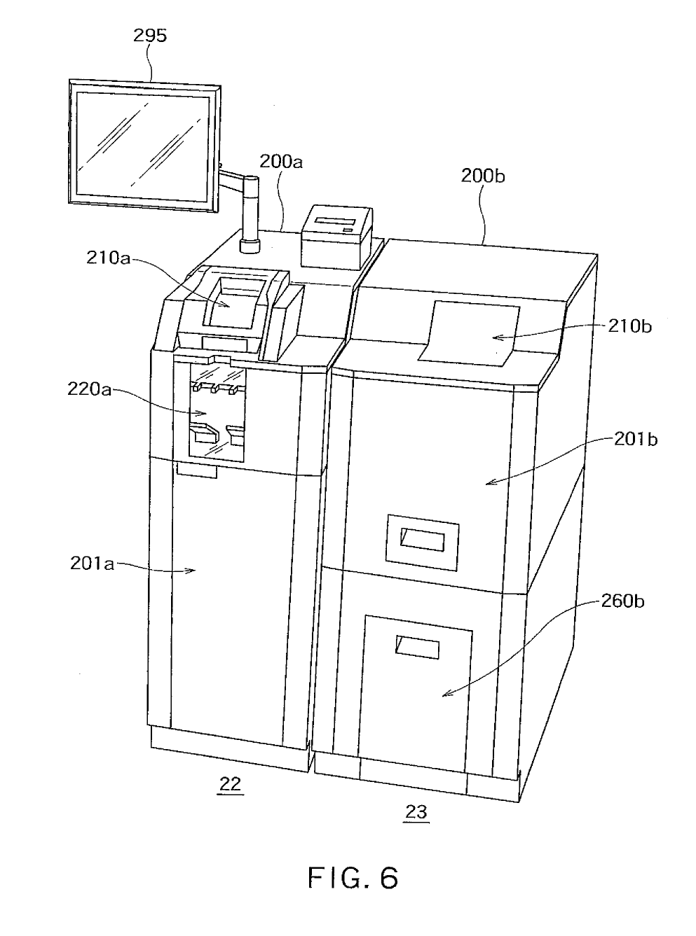

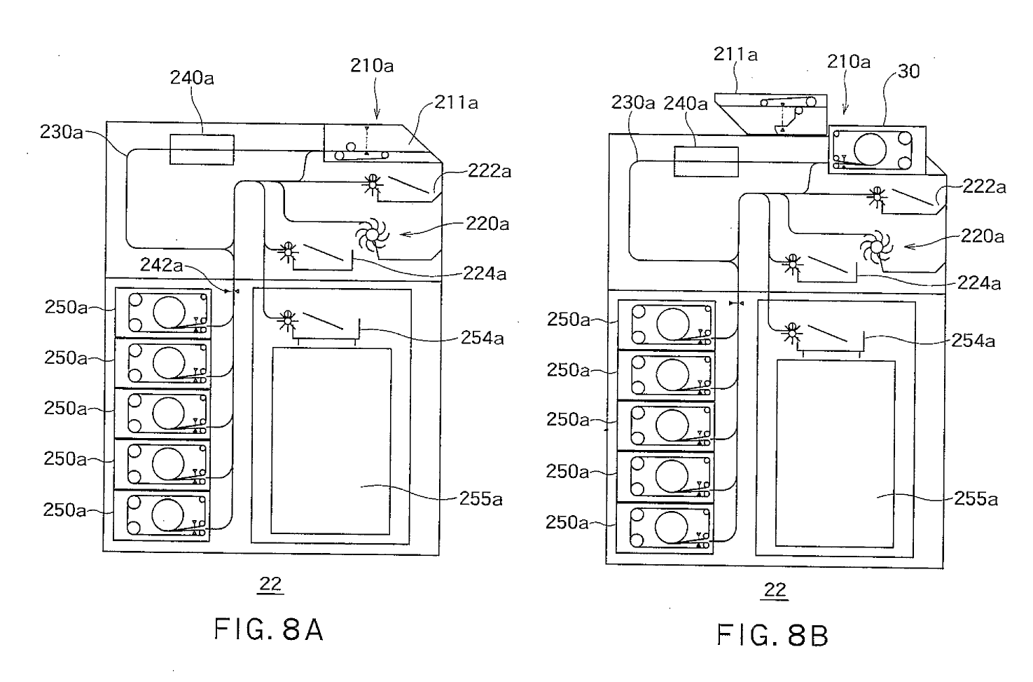

FIG. 6 is a view showing an appearance of an example of the cash accounting apparatus 21. The cash accounting apparatus 21 includes the banknote accounting apparatus 22 and the coin accounting apparatus 23. The banknote accounting apparatus 22 is composed of a housing 200a, a depositing unit 210a, a dispensing unit 220a and an operation display unit 295a. The depositing unit 210a is provided for depositing a banknote(s). The dispensing unit 220a is provided for dispensing a banknote(s). The deposing unit 210a is configured such that a loose-cash feeding unit 211a for feeding loose banknotes or the cash transport cassette 30 can be selectively attached thereto. Thus, the depositing unit 210a can deposit loose banknotes without using the cash transport cassette 30, and can also deposit banknotes from the cash transport cassette 30. The dispensing unit 220a can dispense loose banknotes without using the cash transport cassette 30. When a front cover 201a is opened, there are disposed a collecting unit 255a and a storing unit 250a which are shown in FIG. 8.

The operation display unit 295 is configured to display conditions of the cash accounting apparatus 21, the cash settlement apparatus 11 and the cash transport cassette 30. In addition, an operator can input data through the operation display unit 295. The operation display unit 295 may be a display of a touch panel type, for example.

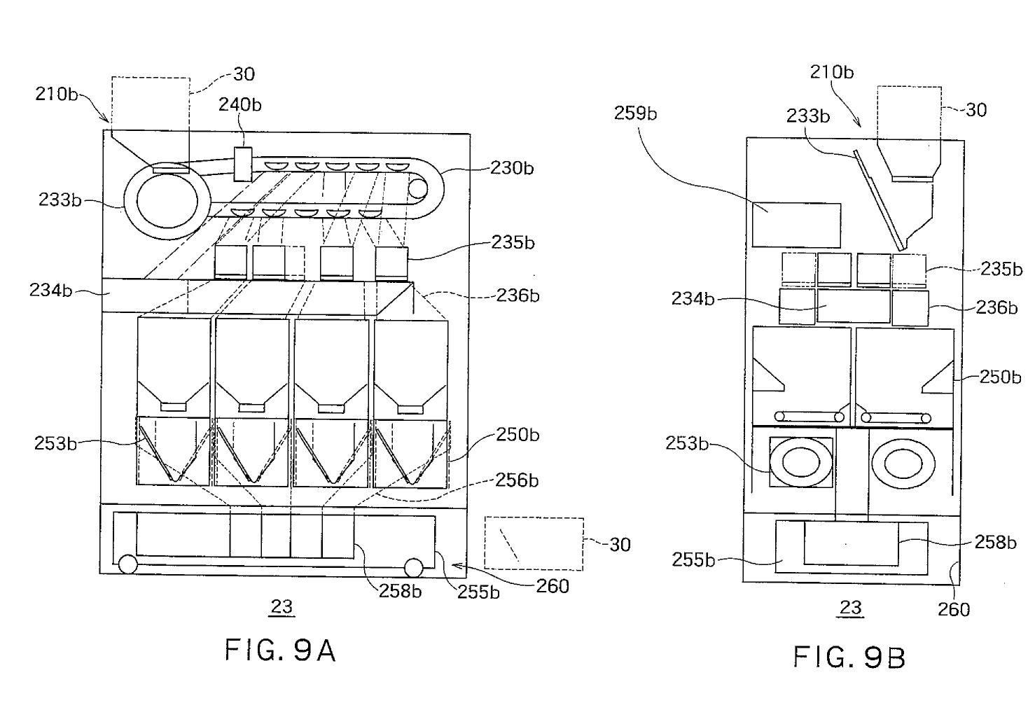

The coin accounting apparatus 23 is composed of a housing 200b, a depositing unit 210b and a drawer attaching unit 260 functioning as a dispensing unit 220b. The depositing unit 210b is provided for depositing a coin(s). The drawer attaching unit 260 is provided for dispensing a coin(s). The depositing unit 210b is configured such that loose coins can be put thereinto as they are, or the cash transport cassette 30 can be attached thereto. Thus, the depositing unit 210b can deposit loose coins without using the cash transport cassette 30, and can also deposit coins from the cash transport cassette 30. The drawer attaching unit 260 is configured such that a storing drawer 258b storing coins by denomination or the cash transport cassette 30 can be selectively attached thereto. Thus, the drawer attaching unit 260 can dispense coins without using the cash transport cassette 30, and can also dispense coins to the cash transport cassette 30. When a front cover 201b is opened, there is disposed a storing unit 250b shown in FIG. 9.

FIG. 7 is a block diagram showing a structural example of the cash accounting apparatus 21. In addition to the depositing unit 210, the dispensing unit 220 and the operation display unit 295, the cash accounting apparatus 21 further includes a transport unit 230, a recognition unit 240, a storing unit 250, a collecting unit 255, a reading/writing unit 257, an apparatus-external reject unit 222, an apparatus-internal reject unit 224, a memory 270, a communication unit 280 and a control unit 290.

The depositing unit 210 of the cash accounting apparatus 21 is configured such that the loose-money feeding unit 201 or the cash transport cassette 30 can be selectively attached thereto. For example, when a clerk deposits loose money to the cash accounting apparatus 21, the loose-money feeding unit 201 is attached to the depositing unit 210. When a clerk deposits cash to the cash accounting apparatus 21 by using the cash transport cassette 30, the cash transport cassette 30, instead of the loose-money feeding unit 201, is attached to the depositing unit 210. Namely, the cash accounting apparatus 21 is configured such that the cash transport cassette 30, instead of the loose-money feeding unit 201, can be attached to and detached from the depositing unit 210.

The transport unit 230 transports cash having been put into the depositing unit 210 to the storing unit 250, or transports cash to be dispensed from the dispensing unit 220, from the storing unit 250. In addition, the transport unit 230 is configured to transport cash from the storing unit 250 to the cash transport cassette 30, or configured to transport cash from the cash transport cassette 30 to the storing unit 250.

The recognition unit 240 is configured to detect a denomination, an authenticity, a fitness, a version and an amount and so on of cash being transported by the transport unit 230. For example, the recognition unit 240 has a sensor such as a magnetic sensor, a fluorescent sensor, a metal thread sensor, a thickness sensor or an image sensor. In addition, the recognition unit 240 is configured to count an amount of cash by denomination.

The storing unit 250 is configured to store, by denomination, cash having been recognized by the recognition unit 240. When banknotes are stored, the storing unit 250 may be a stacking-type storing unit or a tape reeling-type storing unit.

The reading/writing unit 257 is configured to read out information stored in the memory unit 35 disposed on the cash transport cassette 30, and configured to write information to the memory unit 35 as described below.

The memory 270 includes various programs for controlling the cash accounting apparatus 21, a ROM or a HDD storing data, and a RAM serving as a program loading area or a working area when a program is executed, and so on. The memory 270 stores information of cash (a denomination, an amount and so on) stored in the storing unit 250 and the cash transport cassette 30. Further, the memory 270 may store, by denomination, an amount of cash having been recognized by the recognition unit 240.

The communication unit 280 is communicably connected to other apparatuses (the cash accounting apparatus 21, the cash management apparatus 25, the POS management apparatus 26) constituting the cash handling system 1.

The control unit 290 is a processing unit configured to execute a program in the memory 270 to control the cash accounting apparatus 21 as a whole.

FIG. 8A and FIG. 8B are sectional vies showing an example of an inside structure of the banknote accounting apparatus 22 of the cash accounting apparatus 21. FIG. 8A shows a condition in which a loose-banknote feeding unit 211a is attached to the depositing unit 210a, and FIG. 8B shows a condition in which the cash transport cassette 30 is attached to the depositing unit 210a. Illustration of the operation display unit 295 is omitted in FIG. 8.

As shown in FIG. 8A, when a clerk deposits loose banknotes, the clerk attaches the loose-banknote feeding unit 211a to the depositing unit 210a. When the clerk puts loose banknotes into the loose-banknote feeding unit 211a, the loose-banknote feeding unit 211a feeds the fed banknotes, one by one, to the transport unit 230a. The transport unit 230a is configured to cause the fed banknotes to pass through the recognition unit 240a, and then configured to transport the banknotes to the storing unit 250a, a collecting/stacking unit 254a or the apparatus-external reject unit 222a. The recognition unit 240a is configured to recognize a denomination, an authenticity, a fitness, a version, an amount and so on of each of the banknotes being transported. The transport unit 230a is configured to store the banknotes by denomination into the storing units 250a, based on the recognition result by the recognition unit 240a.

When the storing unit 250 is full and so on, the transport unit 230a may transport a banknote to the collecting/stacking unit 254a, as needed. When the number of banknotes stacked in the collecting/stacking unit 254 exceeds the predetermined number, a banknote is stored into the collecting unit 255a. In addition, when a banknote could not be recognized by the recognition unit 240 or a banknote was recognized as a counterfeit note, the transport unit 230a is configured to dispense the banknote to the apparatus-external reject unit 222a.

On the other hand, when a banknote(s) is dispensed, the storing unit 250 is configured to feed banknotes, one by one, to the transport unit 230a. The transport unit 230a transports the fed banknotes to the dispensing unit 220a, and dispenses the banknotes. In the course of transporting the banknotes, when a sensor 242a detects an abnormal transport state such as an overlapped state, a chained state or a skewed state, the transport unit 230a transports the banknotes to the apparatus-internal reject unit 224a.

In this manner, the banknote accounting apparatus 22 can store a banknote having been put into the depositing unit 210a, into the storing unit 250a, and can reversely dispense a banknote having been stored into the storing unit 250a to the dispensing unit 220a. That is to say, the banknote accounting apparatus 22 is configured to reuse a banknote having been put thereinto, as a banknote to be dispensed.

As shown in FIG. 8B, when the loose-banknote feeding unit 211a is rotated upward to be withdrawn and the cash transport cassette 30, instead of the loose banknote feeding unit 201a, is attached to the depositing unit 210a, the banknote accounting apparatus 22 can deposit a banknote from the cash transport cassette 30 to the storing unit 250a, or can dispense a banknote from the storing unit 250a to the cash transport cassette 30. When a banknote(s) is loaded to the cash settlement apparatus 11, the storing unit 250a feeds banknotes, one by one, to the transport unit 230a, in order that the banknotes are transported to the cash transport cassette 30. The transport unit 230a transports the fed banknotes to the cash transport cassette 30. Thus, the banknote accounting apparatus 22 can dispense the banknotes to be loaded to the cash settlement apparatus 11, to the cash transport cassette 30.

When a banknote(s) is collected from the cash settlement apparatus 11, the cash transport cassette 30 already includes banknotes having been collected from the cash settlement apparatus 11. Thus, the cash transport cassette 30 feeds the banknotes contained therein, one by one, to the transport unit 230a, and the transport unit 230a stores the fed banknotes into the storing units 250a. In the course of transporting the banknotes, when the sensor 242a detects an abnormal transport state such as an overlapped state, a chained state or a skewed state, the transport unit 230a transports the banknotes to the apparatus-internal reject unit 224a.

In this manner, the banknote accounting apparatus 22 is configured to dispense banknotes to be loaded to the cash settlement apparatus 11, to the cash transport cassette 30, and configured to deposit a banknote having been collected from the cash settlement apparatus 11 from the cash transport cassette 30.

FIG. 9A and FIG. 9B are sectional views showing an example of an inside structure of the coin accounting apparatus 23 of the money accounting apparatus 21. FIG. 9A is the sectional view of the coin accounting apparatus 23 when viewed from a lateral side, and FIG. 9B is the sectional view of the coin accounting apparatus 23 when viewed from a front side.

The coin accounting apparatus 23 has the depositing unit 210b, and is configured to deposit thereinto a coin having been collected from the money settlement apparatus 11, from the cash transport cassette 30. The coin accounting apparatus 23 includes the drawer attaching unit 260 to which the collecting unit 255b and the cash transport cassette 30 can be attached. When the cash transport cassette 30 is attached to the drawer attaching unit 260, coins to be loaded to the money settlement apparatus 11 can be sorted by denomination, and the sorted cons can be dispensed to the cash transport cassette 30.

When loose coins are deposited, a clerk puts a coin(s) into the depositing unit 210b. At this time, a plurality of coins may be put thereinto in a denomination mixed state. The centrifugal disk-type feeding unit 233b is configured to feed, one by one, coins having been put into the depositing unit 210b, to the transport unit 230b. The transport unit 230b is configured to cause the fed coins to pass through the recognition unit 240b, and then configured to transport the coins to an escrow unit 235b. The escrow units 235b are disposed for respective denominations, and are configured to temporarily store a coin therein.

The recognition unit 240b is configured to recognize a denomination, an authenticity, a fitness, a version, an amount and so on of each of the coins being transported. The transport unit 230b is configured to sort the coins by denomination based on the recognition result by the recognition unit 240b, and configured to transport a coin to the escrow unit 235b of a corresponding denomination.

Each of the escrow units 235b communicate with the storing unit 250b of a corresponding denomination through a chute 236b. After all the coins having been inputted were stored in the escrow units 235b, a coin is stored into the storing unit 250 of a corresponding denomination.

When the storing unit 250b is full and so on, the transport unit 230b may transport a coin to an overflow box 259b. When the escrow unit 235b is full, the transport unit 230b may transport a coin to the overflow box 259b. When a coin was recognized as a reject coin by the recognition unit 240b, the transport unit 230b may transport the reject coin to the reject unit 234b.

On the other hand, when loose coins are dispensed, the storing unit 250b is configured to feed coins, one by one, to the transport unit 231b. Each of the plurality of storing units 250b stores coins by denomination, and has the centrifugal disk-type feeding unit 253b. The feeding unit 253b feeds coins one by one, and transports the coins to a drawer 258b through a chute 256b. The drawer 258b serving as a coin dispensing unit is configured to store cash by denomination. The chute 256b is also configured to dispense cash by denomination. Thus, the coin accounting apparatus 23 can dispense coins by denomination to the drawer 258b. Coins to be collected in the collecting unit 255b may be in a denomination mixed state.

In this manner, the coin accounting apparatus 23 can store a coin having been put into the depositing unit 210b, into the storing unit 250b, and can reversely dispense a coin having been stored into the storing unit 250b to the drawer 258b. That is to say, the coin accounting apparatus 23 is configured to reuse a coin having been put thereinto, as a coin to be dispensed.

There is a case in which the POS register has a drawer into which cash to be handled over the settlement process is manually stored. In this case, the storing drawer 258b is used when a coin is loaded to the drawer of the POS register in the checkout counter 10. A clerk loads a coin(s) having been dispensed to the storing drawer 258b of the coin accounting apparatus 21, to the drawer of the POS register. When a coin(s) is collected from the drawer of the POS register, a clerk may put a coin into the depositing unit 210b. The drawer of the POS register may be the same as the storing drawer 25 of the coin accounting apparatus 21, or may be different therefrom.

When the drawer of the POS register is the same as the storing drawer 258b of the coin accounting apparatus 21, the storing drawer 258b is attached to the coin accounting apparatus 21 upon loading process, and is attached to the POS register upon settlement process. In this case, it is not necessary for a clerk to transmit a coin from the storing drawer 258b of the coin accounting apparatus 21 to the drawer of the POS register. In addition, since the coin accounting apparatus 21 sorts coins by denomination and dispenses the sorted coins to the storing drawer 258b, a clerk can perform a settlement process immediately after the storing drawer 258b has been attached to the coin accounting apparatus 21.

Meanwhile, when the drawer of the POS register is different from the storing drawer 258b of the coin accounting apparatus 21, the storing drawer 258b is attached to the coin accounting apparatus 21 upon loading process. A clerk transmits cash having been dispensed to the storing drawer 258b, to the POS register upon settlement process. In this case, the structure of the storing drawer 258b of the coin accounting apparatus 21 may be different from the structure of the drawer of the POS register.

When the cash transport cassette 30 is attached to the depositing unit 210b, the coin accounting apparatus 23 can deposit thereinto a coin having been collected from the cash settlement apparatus 11, from the cash transport cassette 30. When a clerk attaches the cash transport cassette 30 to the depositing unit 210b, the cash transport cassette 30 puts a coin(s) into the feeding unit 233b. At this time, money may be put thereinto in a denomination mixed state. An operation succeeding thereto is the same as an operation when loose coins are deposited. Thus, coins are stored by denomination into the storing units 250b.

When the cash transport cassette 30, instead of the collecting unit 255b, is attached, the coin accounting apparatus 23 can dispense a coin(s) to be loaded to the cash settlement apparatus 11, to the cash transport cassette 30. In this case, similarly to a case where loose coins are dispensed, coins are dispensed from the storing units 250b to the cash transport cassette 30 through the chutes 256b. At this time, the coins having been dispensed to the cash transport cassette 30 may be in a denomination mixed state.

In this manner, the coin accounting apparatus 23 can store a coin from the cash transport cassette 30 into the storing unit 250b, and can reversely dispense a coin having been stored into the storing unit 250b to the cash transport cassette 30.

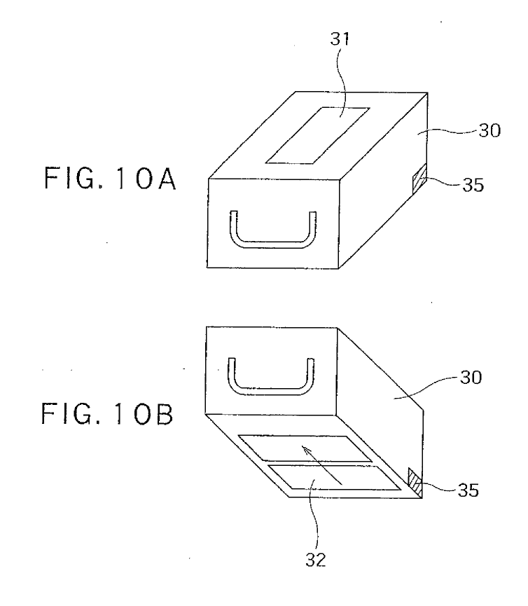

FIG. 10A and FIG. 10B are outline views showing a structural example of the cash transport cassette 30 configured to transport a coin(s). The cash transport cassette 30 configured to transport a coin(s) has an upper opening 31 and a lower opening 32.

For example, a case where a coin(s) is collected from the coin settlement apparatus 13 shown in FIG. 5A is described. When the cash transport cassette 30 is attached to the cassette attaching unit 160b, an actuator (not shown) disposed on the coin settlement apparatus 13 opens the upper opening 31 of the cash transport cassette 30. At this time, the lower opening 32 remains closed. Thus, the coin settlement apparatus 13 can put the coin to be collected into the cash transport cassette 30 through the upper opening 31.

A case where a coin(s) is loaded to the coin settlement apparatus 13 is described. When the cash transport cassette 30 is attached to the cassette attaching unit 160b, the actuator disposed on the coin settlement apparatus 13 opens the lower opening 32 of the cash transport cassette 30. Thus, the coin in the cash transport cassette 30 is dispensed to the feeding unit 137b through the lower opening 32.

When a coin to be loaded is put from the coin accounting apparatus 23 shown in FIG. 9A into the cash transport cassette 30, the cash transport cassette 30 is attached in place of the drawer 258b. At this time, an actuator disposed on the coin accounting apparatus 23 opens the upper opening 31 of the cash transport cassette 30. The lower opening 32 remains closed. Thus, the coin accounting apparatus 23 can deposit the coin through the upper opening 31.

When a coin having been collected from the coin accounting apparatus 13 by using the cash transport cassette 30 is collected to the coin accounting apparatus 23, the cash transport cassette 30 is attached to the depositing unit 210b. At this time, the actuator disposed on the coin accounting apparatus 23 opens the lower opening 32 of the cash transport cassette 30. The upper opening 31 remains closed. Thus, the coin in the cash transport cassette 30 is dispensed to feeding unit 233b through the lower opening 32.

The cash transport cassette 30 includes the memory unit 35 which at least stores cassette ID information for specifying the cash transport cassette 30. When there are the plurality of cash transport cassettes 30 in the cash handling system 1, the cash transport cassettes 30 have cassette ID information that are different from each other. Thus, the cash settlement apparatus 11 and the cash accounting apparatus 21 can specify a cash transport cassette 30. The cassette ID information may be a unique number set to each of the plurality of cash transport cassettes 30. The memory unit 35 may store information such as a denomination, an amount and so on of cash stored in the cash transport cassette 30 as needed.

It can be considered that the cash settlement apparatus is connected, for communication, with neither the cash accounting apparatus 21 nor the cash management apparatus 25. In this case, the memory unit 35 of the cash transport cassette 30 may store, not only the cassette ID information of itself, but also denomination information and amount information of cash to be loaded or collected, as well as ID information of the cash settlement apparatus 11 to which the cash is loaded or from which the cash is collected. Thus, the cash settlement apparatus 11 can recognize that the cash settlement apparatus 11 itself is an object to be loaded, and can also recognize a denomination and an amount of the cash to be loaded. In addition, the cash accounting apparatus 21 can recognize from which one of cash settlement apparatuses 11 the cash in the cash transport cassette 30 has been collected, and can also recognize a denomination and an amount of the collected cash. Namely, even when the cash settlement apparatus 11 is connected, for communication, with neither the cash accounting apparatus 21 nor the cash management apparatus 25, the cash loading process and the cash collecting process can be performed, as long as the memory unit 35 of the cash transport cassette 30 stores denomination information and amount information of cash to be loaded or collected and ID information of the cash settlement apparatus 11 to which the cash is loaded or from which the cash is collected.

(Operation of Cash Handling System 1)

Next, a concrete operation of the cash handling system 1 in this embodiment is described. A sum of cash in each cash settlement apparatus 11, a sum of cash in the cash accounting apparatus 21, a sum of cash deposited into or dispensed from each cash settlement apparatus 11 and a sum of cash having been loaded or collected between the cash accounting apparatus 21 and each cash settlement apparatus 11 are all managed by the cash management apparatus 25. The plurality of cash settlement apparatuses 11 respectively have unique ID information so as to be differentiated from each other, and each memory 170 of each of the cash settlement apparatuses 11 stores the ID information. The cash management apparatus 25 also recognizes the ID information of each cash settlement apparatus 11. In the below processes, communication between each cash settlement apparatus 11 and the cash accounting apparatus 21 is performed via the cash management apparatus 25. However, it is a matter of course that each cash settlement apparatus 11 and the cash accounting apparatus 21 can directly communicate with each other.

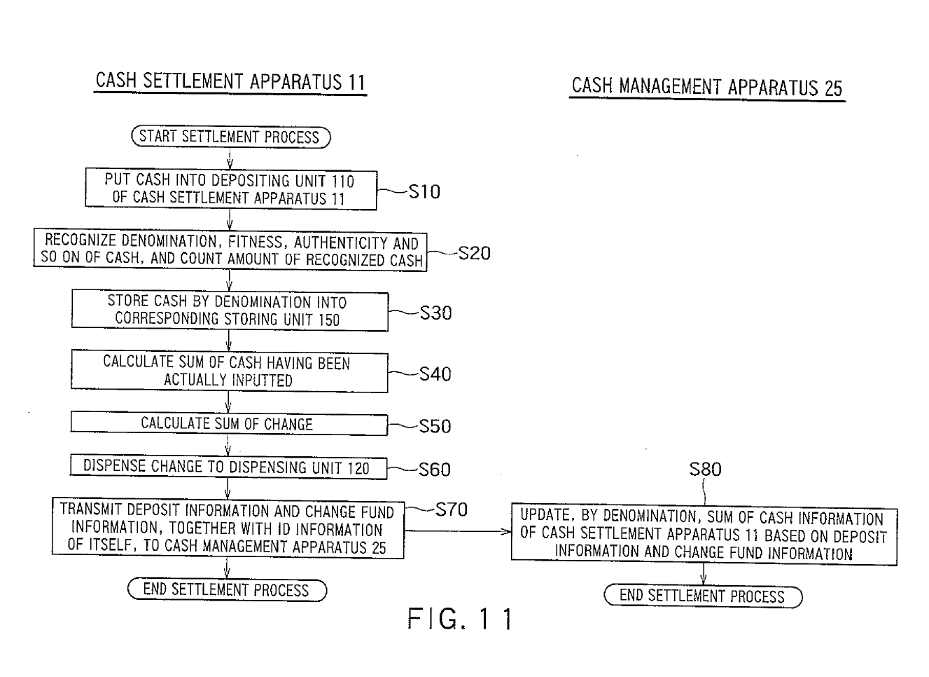

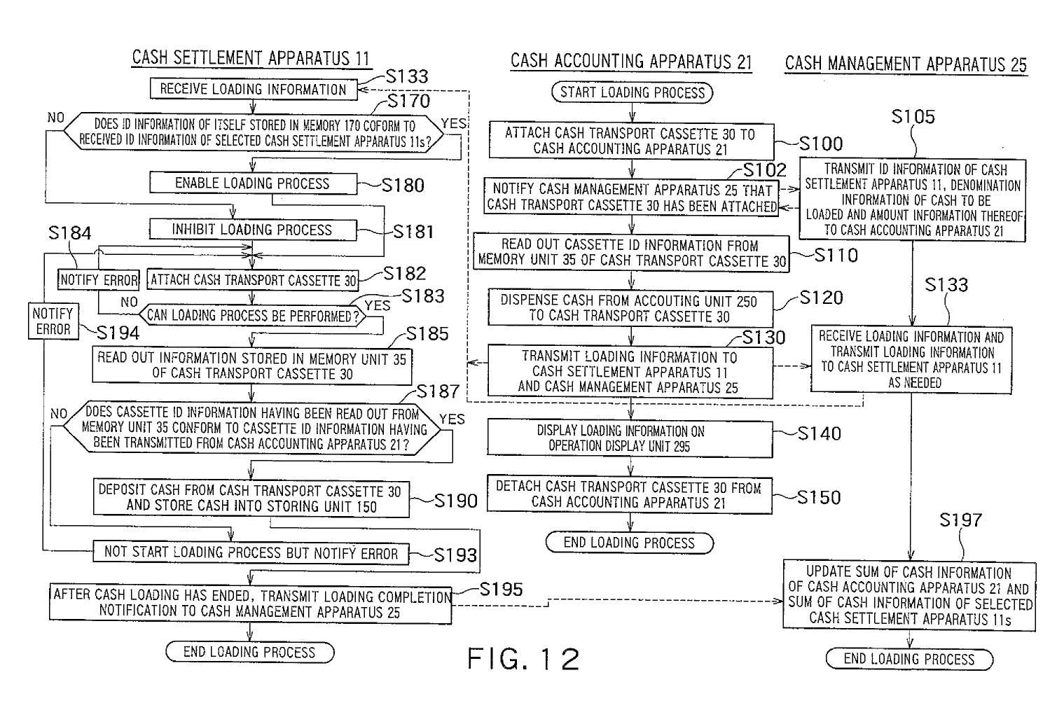

The cash handling system 1 can be applied both to a banknote and to a coin, in a settlement process, a loading process and a collecting process shown in FIGS. 11 and 12. For example, when a banknote is handled, the banknote settlement apparatus 12 of the cash settlement apparatus 11 may be used, and the banknote accounting apparatus 22 of the cash accounting apparatus 21 may be used. In addition, a cash transport cassette for banknote (either a stacking type or a tape reeling type will do) may be used as the cash transport cassette 30.

On the other hand, when a coin is handled, the coin settlement apparatus 13 of the cash settlement apparatus 11 may be used, and the coin settlement apparatus 23 of the cash accounting apparatus 21 may be used. In addition, the cash transport cassette for coin shown in FIG. 10A and FIG. 10B may be used as the cash transport cassette 30. Herebelow, although a banknote and a coin are expressed as “cash” for the sake of convenience, the term “cash” may be replaced with either “banknote” or “coin”.

(Settlement Process)

FIG. 11 is a flowchart showing an operation of a settlement process in the cash handling system 1 in this embodiment. Upon settlement process, in the checkout counter 10, a clerk puts cash having been received from a customer, into the depositing unit 110 (S10). When the checkout counter 10 is of the self-checkout type, the customer puts cash into the depositing unit 110.

The recognition unit 140 recognizes a denomination, a fitness, an authenticity and so on of the inputted cash that is being transported, and counts an amount of the cash having been recognized (S20). The cash settlement apparatus 11 stores the inputted cash by denomination to the corresponding storing unit 150 (S30). A counterfeit cash and a cash that cannot be recognized are dispensed to the dispensing unit 120 so as to be returned to a clerk or a customer.

The deposit information (information such as a denomination, an amount, a fitness, an authenticity and so on) of the cash having been recognized and counted by the recognition unit 140 is stored in the memory 170. The control unit 190 calculates a sum of the cash having been actually inputted, based on the deposit information in the memory 170 (S40). For example, the control unit 190 multiplies, for each denomination, a value of a denomination of the inputted cash and an amount thereof. Then, the control unit 190 can calculate a total sum of the inputted cash by adding the multiplication results for the respective denominations. Thereafter, the control unit 190 deducts a product price from the sum of actually inputted cash to calculate a change sum (S50). The change information (a denomination and an amount) may be stored in the memory 170.

The cash settlement apparatus 11 dispenses change to the dispensing unit 120 in accordance with the change sum having been calculated by the control unit 190 (S60). At this time, the cash to be dispensed is dispensed such that cash is preferentially selected in a descending order of denomination. However, when cash of a large denomination is lacking, the cash settlement apparatus 11 may substitute cash of a smaller denomination for the cash of the large denomination. For example, when a 5,000-yen banknote is lacking, the cash settlement apparatus 11 may dispense five 1,000-yen banknotes in place of one 5,000-yen banknote. A denomination of cash to be dispensed as change is selected by the control unit 190 or the cash management apparatus 25.

The cash settlement apparatus 11 transmits the deposit information and the change information stored in the memory 170, together with ID information thereof, to the cash management apparatus 25 (S70). When the cash management apparatus 25 has received the deposit information, the change information and the ID information of the cash settlement apparatus 11, the cash management apparatus 25 specifies the cash settlement apparatus 11 that has performed the settlement process, and updates, by denomination, sum of cash in the cash settlement apparatus 11 based on the deposit information and the change information (S80).

For example, suppose that a customer hands over a 10,000-yen banknote to a clerk, when the customer buys a product of 5,200 yen. In this case, a denomination of cash to be inputted is 10,000 yen, and an amount is one. A sum of inputted cash is 10,000 yen (10,000-yen banknote×1) and a change sum is 4,800 yen. Thus, the banknote settlement apparatus 12 of the cash settlement apparatus 11 feeds four 1,000-yen banknotes from the storing unit 150a and dispenses the four 1,000-yen banknotes to the dispensing unit 120a. The coin settlement apparatus 13 feeds one 500-yen coin and three 100-yen coins from the storing units 150b and dispenses the one 500-yen coin and the three 100-yen coins to the dispensing unit 120b.

The cash settlement apparatus 11 transmits, to the cash management apparatus 25, the ID information thereof, the denomination (10,000-yen banknote) and the amount (one) of the inputted cash (deposit information), and the denomination and the amount of change (1,000-yen banknote: four; 500-yen coin: one; 100-yen coin: three) (change information).

The cash management apparatus 25 adds the deposit sum (denomination×amount) obtained from the deposit information, to the sum of cash information of the cash settlement apparatus 11 having been specified by the ID information. In the above example, sum of 10,000-yen banknote, among sum of cash information of respective denominations of the banknote settlement apparatus 12, is increased by 10,000 yen. Alternatively, when the cash management apparatus 25 manages sum of cash information of the cash settlement apparatus 11 based on an amount of each denomination, the cash management apparatus 25 may add an amount of deposit information to amount information of the cash settlement apparatus 11. For example, the cash management apparatus 25 increases the amount of 10,000 yen banknote among amount information of the banknote settlement apparatus 11 by one.

In addition, the banknote management apparatus 25 deducts the change sum (denomination×amount) obtained by the change information, from the sum of cash information of the cash settlement apparatus 11 having been specified by the ID information. In the above example, sum of cash information of 1,000-yen banknote, among sum of cash information of the banknote settlement apparatus 12, is decreased by 4,000 yen. Sum of cash information of 500-yen coin, among sum of cash information of the coin settlement apparatus 13, is decreased by 500 yen. Sum of cash information of 100-yen coin is increased by 300 yen. Alternatively, when the cash management apparatus 25 manages sum of cash information of the cash settlement apparatus 11 based on an amount of each denomination, the cash management apparatus 25 may deduct the amount in the change information from the amount information of the cash settlement apparatus 11. In the above example, an amount of 1,000-yen banknote, among the amount information of the banknote settlement apparatus 12, is decreased by four. An amount of 500-yen coin, among the amount information of the coin settlement apparatus 13, is decreased by one. An amount of 100-yen coin is reduced by three.

In this manner, the cash settlement apparatus 11 performs a settlement process in the checkout counter 10 of a store, and the cash management apparatus 25 updates sum of cash information of the cash settlement apparatus 11 in accordance with deposit information and change information. Thus, a series of settlement processes are completed.

(Loading Process)

FIG. 12 is a flowchart showing an operation of a loading process in the cash handling system 1 in this embodiment.

Before store hours, a clerk should load each cash settlement apparatus 11 with a change fund. In this embodiment, a clerk transports a change fund from the cash accounting apparatus 21 to the cash settlement apparatus 11, with the use of the cash transport cassette 30.

Since the cash management apparatus 25 manages sum of cash information by denomination of each cash settlement apparatus 11, a cash settlement apparatus 11 to be loaded with cash and a denomination of cash to be loaded can be determined beforehand. The cash settlement apparatus 11 to be loaded with cash (e.g., change fund) and the denomination of cash to be loaded are displayed on the operation display unit 295 of the cash accounting apparatus 21. Thus, a clerk can recognize the cash settlement apparatus 11 to be loaded with cash and the denomination of cash to be loaded.

A clerk firstly selects a start of loading process in the cash accounting apparatus 21 or the cash management apparatus 25, and attaches the cash transport cassette 30 containing no cash on the cash accounting apparatus 21 (S100). When a banknote is transported, the clerk attaches the cash transport cassette 30 for transporting banknotes to the banknote accounting apparatus 22. When a coin is transported, the clerk attaches the cash transport cassette 30 for transporting coins to the coin accounting apparatus 23. When the cash transport cassette 30 is attached, the cash accounting apparatus 21 notifies the cash management apparatus 25 that the cash transport cassette 30 has been attached (S102).

Further, upon receipt of the notification that the cash transport cassette 30 has been attached, the cash management apparatus 25 transmits ID information of the cash settlement apparatus 11 to be loaded with cash, and denomination information of cash to be loaded and amount information thereof, to the cash accounting apparatus 21 (S105).

When the cash transport cassette 30 has been attached to the cash accounting apparatus 21, the reading/writing unit 257 of the cash accounting apparatus 21 reads out the cassette ID information from the memory unit 35 of the cash transport cassette 30 (S110). The cash accounting apparatus 21 dispenses cash to be loaded to the cash settlement apparatus 11 to be loaded with a change fund (hereinafter referred to as “selected cash settlement apparatus 11s”), from the storing unit 250 to the cash transport cassette 30 (S120).

The cash accounting apparatus 21 transmits the ID information of the selected cash settlement apparatus 11s having been received from the cash management apparatus 25, the cassette ID information of the cash transport cassette 30 containing a change fund, denomination information of the change fund and amount information thereof, to the cash settlement apparatus 11 installed in the checkout counter 10 and the cash management apparatus 25, such that the information are correlated to each other (S130). The reading/writing unit 257 of the cash accounting apparatus 21 may write the ID information of the selected cash settlement apparatus 11s, the cassette ID information of the cash transport cassette 30 containing the change fund, and the denomination information of the change fund and the amount information thereof, to the memory unit 35 of the cash transport cassette 30. For example, when the cash settlement apparatus 11 is connected, for communication, with neither the cash accounting apparatus 21 nor the cash management apparatus 25, the memory unit 35 of the cash transport cassette 30 is required to store the ID information of the selected cash settlement apparatus 11s, the cassette ID information of the cash transport cassette 30 containing the change fund, the denomination information of the change fund and the amount information thereof.

Herebelow, the ID information of the selected cash settlement apparatus 11s, the cassette ID information of the cash transport cassette 30 containing the change fund, the denomination information of the change fund and the amount information thereof are referred to as “loading information”.

The cash management apparatus 25 and the cash settlement apparatus 11 receive the loading information, and store the loading information (S133).

When the cash transport cassette 30 is a tape reeling-type cassette, the memory unit 35 may store a denomination of banknotes received therein in a reeled order. In this case, when banknotes are loaded to the selected cash settlement apparatus 11s, the banknotes are fed out in an order reverse to the reeled order. Thus, the selected cash settlement apparatus 11s can specify a denomination of the fed banknote, without the banknote being recognized by the recognition unit 140. Thus, the selected banknote settlement apparatus 11s can store, by denomination, the banknotes from the cash transport cassette 30, in accordance with the reeled order stored in the memory unit 35. Therefore, a process of loading cash to the selected cash settlement apparatus 11s can be accelerated. The information about the reeled order of banknotes may be transmitted to the cash settlement apparatus and the cash management apparatus 25 through the communication unit 280. It is a matter of course, even when the cash transport cassette 30 is a tape reeling-type cassette, the recognition unit 140 of the selected cash settlement apparatus 11s may recognize banknotes to be loaded. Thus, the selected cash settlement apparatus 11s can confirm a denomination and an amount of the banknotes to be loaded.

Following thereto, the cash accounting apparatus 21 causes the operation display unit 295 to display the loading information (S140). Thus, a clerk can specify the selected cash settlement apparatus 11s to be loaded with a change fund, and can transport the cash transport cassette 30 to the selected cash settlement apparatus 11s.

Then, the clerk detaches the cash transport cassette 30 from the cash accounting apparatus 21 (S150). Thereafter, the clerk transports the cash transport cassette 30 to the selected cash settlement apparatus 11s in order to load the change fund.

The control unit 190 of each of the cash settlement apparatuses 11 installed in the checkout counter 10 compares the ID information of itself stored in the memory 170 with the received ID information of the selected cash settlement apparatus 11s (S170). When the ID information of itself and the ID information of the selected cash settlement apparatus 11s conform to each other (YES in S170), the cash settlement apparatus 11 recognizes that it is the selected cash settlement apparatus 11s and enables the loading process (5180). When the ID information of itself and the ID information of the selected cash settlement apparatus 11s do not conform to each other (NO in S170), the cash settlement apparatus 11 recognizes that it is not selected as an object to be loaded and disables the cash loading process (S181). When the clerk has attached the cash transport cassette 30 to the cash settlement apparatus 11 (S182), the cash settlement apparatus 11 judges whether the loading process is possible or not (S183).

When the cash transport cassette 30 is attached to an unselected cash settlement apparatus 11, the unselected cash settlement apparatus 11 does not start the loading process and notifies the clerk of the error (S184). The error may be notified by displaying the error on the monitor, turning on an alarm lamp, or outputting an alarm sound. In this case, the clerk should reattach the cash transport cassette 30 to the selected cash settlement apparatus 11s.

When the cash transport cassette 30 has been attached to the selected cash settlement apparatus 11s (YES in S183), the reading/writing unit 157 of the selected cash settlement apparatus 11 reads out information stored in the memory unit 35 of the cash transport cassette 30 (S185).

Then, the control unit 190 of the selected cash settlement apparatus 11s compares the cassette ID Information having been read out from the memory unit 35 with the cassette ID information having been transmitted from the cash accounting apparatus 21 or the cash management apparatus 25 (S187).

When change funds are simultaneously loaded to the plurality of cash settlement apparatuses 11, there is a case in which the plurality of cash settlement apparatuses 11 are the selected cash settlement apparatuses 11s. In this case, the cash transport cassettes 30 the number of which is equal to that of the selected cash settlement apparatuses 11s simultaneously transport cash. Thus, as shown in step S187, since the cassette ID information having been read out from the memory unit 35 and the cassette ID Information having been transmitted from the cash accounting apparatus 21 are compared to each other, it can be prevented that the cash transport cassette 30 is attached to an unintended selected cash settlement apparatus 11s. When the cassette ID information compared in the step S187 have conformed to each other (YES in S187), it can be understood that the cash transport cassette 30 is attached to the intended selected cash settlement apparatus 11s to be loaded with cash. Thus, the selected cash settlement apparatus 11s deposits the cash from the cash transport cassette 30, and store the cash into the storing unit 150 (S190).

When the cassette ID Information do not conform to each other (NO in S187), it means that the selected cash settlement apparatus 11s to which the cash transport cassette 30 is attached is not the selected cash settlement apparatus 11s to which the cash transport cassette 30 should load cash. Namely, it means that the cash transport cassette 30 is attached to another selected cash settlement apparatus 11s. Thus, the selected cash settlement apparatus 11s does not start the loading process, but notifies a clerk of the error (S193, S194). The clerk having been notified of the error reattaches the cash transport cassette 30 to the corresponding selected cash settlement apparatus 11s (S181).

When the cash transport cassette 30 has been attached to the cash transport cassette 30 to be loaded with cash (YES in S187), the error is cancelled.

In the step S190, when cash is deposited from the cash transport cassette 30, the recognition unit 140 may count an amount of loaded cash by denomination. In this case, the control unit 190 compares an amount of each denomination of the change fund having been actually loaded, with amount information for each denomination having been received from the cash accounting apparatus 21 or the cash management apparatus 25. Since a clerk cannot touch the cash in the cash transport cassette 30 during the cash transportation, the amount of each denomination of the change fund having been actually loaded, and the amount information for each denomination having been received from the cash accounting apparatus 21 generally conform to each other. When they conform to each other, the cash settlement apparatus 11 stores the change fund into the storing unit 150. However, if they do not conform to each other, the loading process is stopped, and the cash settlement apparatus 11, the cash accounting apparatus 21 or the cash management apparatus 25 notifies the error. In this case, since an investigation by a manager is needed, the error is continuously notified until the error is cancelled. As needed, the change fund is returned to the cash transport cassette 30.

After the cash loading process has ended, the selected cash settlement apparatus 11s transmits a loading completion notification to the cash management apparatus 25 (S195). Thereafter, the cash settlement apparatus 11 can start the settlement process. During the settlement process, the cash transport cassette 30 may remain to be attached to the cash settlement apparatus 11. Thus, the cash transport cassette 30 can collect cash, when the storing unit 150 becomes full.

Upon receipt of the loading completion notification, the cash management apparatus 25 updates the sum of cash information of the cash accounting apparatus 21 and the sum of cash information of the selected cash settlement apparatus 11s (S197). The cash management apparatus 25 can update the sum of cash information of the cash accounting apparatus 21 based on the denomination information of the change fund and the amount information thereof, which have been received from the cash accounting apparatus 21. In addition, the cash management apparatus 25 can update the sum of cash information of the selected cash settlement apparatus 11s based on the ID information of the selected cash settlement apparatus 11s, the denomination information of the change fund and the amount information thereof, which have been received from the cash accounting apparatus 21. Thus, a series of loading processes are completed.

When the cash settlement apparatus 11 is connected, for communication, with neither the cash accounting apparatus 21 nor the cash management apparatus 25, the reading/writing unit 157 of the selected cash settlement apparatus 11 reads out the loading information from the memory unit 35 of the cash transport cassette 30 in the step S185. After that, when the operation succeeding to the step S170 is performed, the cash handling system can perform the loading process.

(Collecting Process)

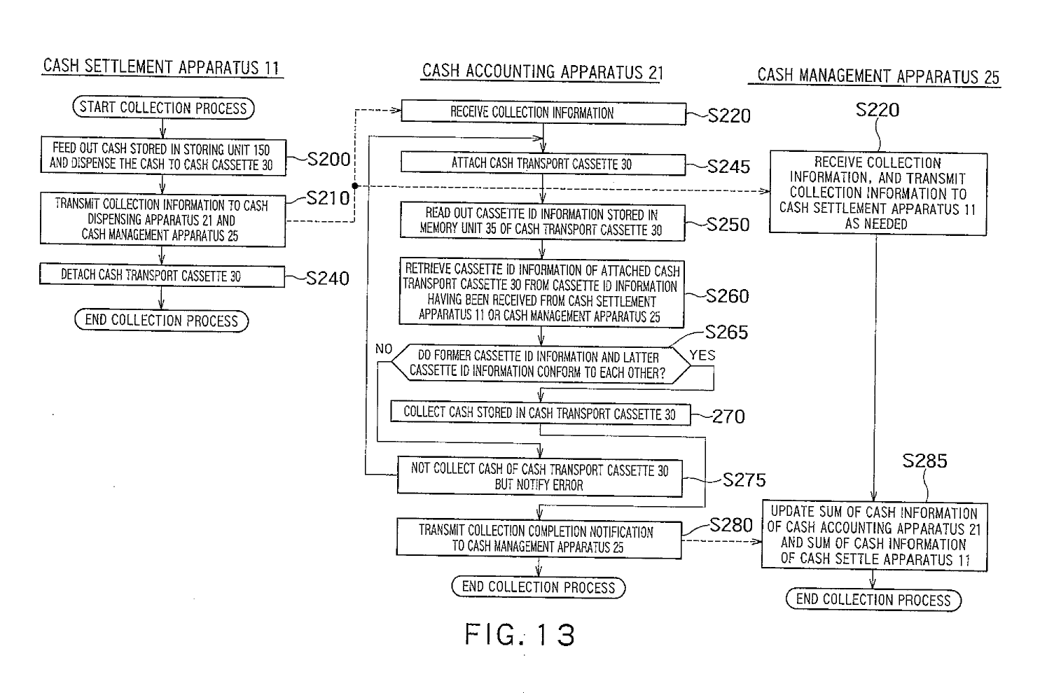

FIG. 13 is a flowchart showing an operation of a collecting process in the cash handling system 1 in this embodiment.

Upon closing of a store or in a predetermined stage during store hours, a clerk should collect sales proceeds stored in each of the cash settlement apparatuses 11 to the cash accounting apparatus 21. In this embodiment, a clerk collects sales proceeds from the cash settlement apparatus 11 to the cash accounting apparatus 21 with the use of the cash transport cassette 30.

When a clerk selects a start of a collecting process in the cash settlement apparatus 11, the cash accounting apparatus 21 or the cash management apparatus 25, the cash settlement apparatus 11 feeds cash stored in the storing unit 150 and dispenses the cash to the cash transport cassette 30 (S200). At this time, the cash settlement apparatus 11 leaves cash of a predetermined amount required as a change fund in each of the storing units 150 of respective denominations, and dispenses excessive cash to the cash transport cassette 30. When an amount of cash stored in the storing unit 150 of a certain denomination is not more than a predetermined amount required as a change fund, the cash settlement apparatus 11 does not need dispense cash of the denomination. Thus, an amount of cash transported during the loading process can be reduced. Since sum of cash information of the cash settlement apparatus 11 is managed by the cash management apparatus 25, the cash management apparatus 25 may set a denomination of cash to be collected from the case settlement apparatus 11.

The cash settlement apparatus 11 transmits ID Information of itself, cassette ID information of the cash transport cassette 30 containing cash to be collected (hereinafter referred to as collection cash), denomination information of the collection cash and amount information of thereof, to the cash accounting apparatus 21 and the cash management apparatus 25, which are installed in the back office 20, such that the information are correlated to each other (S210). Herebelow, the ID Information of itself, the cassette ID information of the cash transport cassette 30 containing collection cash, the denomination information of the collection cash and the amount information thereof are referred to as “collection information”.

The cash accounting apparatus 21 and the cash management apparatus 25, which are installed in the back office 20, receive the collection information from the cash settlement apparatus 11 and store the collection information (S220). The reading/writing unit 157 of the cash settlement apparatus 11 may write the collection information to the memory unit 35 of the cash transport cassette 30.

When the cash transport cassette 30 is a tape reeling-type cassette, the memory unit 35 may store a denomination of banknotes received therein in a reeled order. In this case, when banknotes are collected to the cash accounting apparatus 21, the banknotes are fed out in an order reverse to the reeled order. Thus, the cash accounting apparatus 21 can specify a denomination of the fed banknote, without the banknote being recognized by the recognition unit 240, and can store the banknotes from the cash transport cassette 30 in accordance with the reeled order stored in the memory unit 35. Thus, a process for collecting cash from the cash settlement apparatus 11 can be accelerated. The information about the reeled order of banknotes may be transmitted to the cash accounting apparatus 21 and the cash management apparatus 25 through the communication unit 180.

Following thereto, the clerk detaches the cash transport cassette 30 from the cash settlement apparatus 30 (S240). Then, the clerk transports the cash transport cassette 30 to the cash accounting apparatus 21. In general, since the number of the cash accounting apparatus 21 disposed in the cash handling system 1 is one, the clerk may transport the cash transport cassette 30 to the cash accounting apparatus 21 without pause. However, when the plurality of cash accounting apparatuses 21 are disposed in the money handling system 1, a clerk can transport the cash transport cassette 30 to any of the cash accounting apparatuses 21, as long as the cash management apparatus 25 manages respective sum of cash information of all the cash accounting apparatuses 21.

When the clerk has attached the cash transport cassette 30 to the cash accounting apparatus 21 (S245), the reading/writing unit 257 of the cash accounting apparatus 21 reads out information (cassette ID information and collection information) stored in the memory unit 35 of the cash transport cassette 30 (S250).

The control unit 290 of the cash accounting apparatus 21 retrieves cassette ID information of the cash transport cassette 30 attached thereto, among the cassette ID information having been received from the cash settlement apparatus 11 or the cash management apparatus 25 (S260). For example, when the cash accounting apparatus 21 receives a plurality of cassette ID information, it is necessary to specify which cash transport cassette 30 is attached thereto. Thus, by comparing the cassette ID information of the cash transport cassette 30 attached thereto with all received the cassette ID information, the cash accounting apparatus 21 specifies the cash transport cassette 30 attached thereto.

In the step S260, the cash transport cassette 30 may be specified by using ID information of the cash settlement apparatus 11 together with the cassette ID information or instead thereof. When the cash transport cassette 30 is specified by using the ID information of the cash settlement apparatus 11, the ID information of the cash settlement apparatus 11 stored in the memory unit 35 of the cash transport cassette 30, and the ID information of the cash settlement apparatus 11 having been received in the step S220 may be compared to each other. Thus, it can be understood from which cash settlement apparatus 11 the collection cash in the cash transport cassette 30 has been collected.

When the cash transport cassette 30 has been specified (YES in S265), the denomination information of the collection cash and the amount information thereof, which are correlated to the cassette ID information of the attached cash transport cassette 30, can be known. The cash accounting apparatus 21 collects the cash stored in the cash transport cassette 30 (S270). The collected cash is stored into the storing unit 250 of the cash accounting apparatus 21.

After the retrieval, when the cassette ID information having been read out from the memory unit 35 does not confirm to the cassette ID information having been transmitted from the cash settlement apparatus 11 or the cash management apparatus 25 (NO in S265), the cash accounting apparatus 21 does not collect the cash in the cash transport cassette 30, but notifies a clerk of the error (S275). The error may be displayed on the operation display unit 295. The clerk having been notified of the error copes with the error, by, e.g., attaching a right cash transport cassette 30 so as to cancel the error.

When the cash is deposited from the cash transport cassette 30 in step S270, the recognition unit 240 may count, by denomination, an amount of the cash to be collected. In this case, the control unit 290 compares an amount of cash of each denomination having been actually collected and the amount information of collection cash of each denomination having been received from the cash settlement apparatus 11 or the cash management apparatus 25. Since a clerk cannot touch the cash in the cash transport cassette 30 during the cash transportation, the amount of cash having been actually collected and the amount information of collection cash having been received from the cash settlement apparatus 11 or the cash management apparatus 25 generally conform to each other. When they conform to each other, the cash accounting apparatus 21 stores the collection cash into the storing unit 250. However, if they do not conform to each other, the cash accounting apparatus 21 stops the collection process, and the cash accounting apparatus 21 or the cash management apparatus 25 notifies the error. In this case, since an investigation by a manager is needed, the error is continuously notified until the error is cancelled. As needed, the collection cash is returned to the cash transport cassette 30.

After the cash collection process has ended, the cash accounting apparatus 21 transmits a collection completion notification to the cash management apparatus 25 (S280).

Upon receipt of the collection completion notification, the cash management apparatus 25 updates the sum of cash information of the cash accounting apparatus 21 and the sum of cash information of the cash settlement apparatus 11 (S285). The cash management apparatus 25 updates the sum of cash information of the cash settlement apparatus 11 and the sum of cash information of the cash accounting apparatus 21, based on the ID information of the cash settlement apparatus 11, the denomination information of the collection cash and the amount information thereof, which have been received from the cash settlement apparatus 11. Thus, a series of collection processes are completed.

When the cash settlement apparatus 11 is connected, for communication, with neither the cash accounting apparatus 21 nor the cash management apparatus 25, the reading/writing unit 257 of the cash accounting apparatus 21 reads out the collection information from the memory unit 35 of the cash transport cassette 30 in the step S250. After that, when the operation succeeding to the step S260 is performed, the cash handling system can perform the collection process.

When the plurality of cash transport cassettes 30 are used in the collection process, the cash transport cassettes 30 may be successively attached to the cash accounting apparatus 21. By repeating the steps S200 to S285, the cash accounting apparatus 21 can successively collect cash in the plurality of cash transport cassettes 30.

In this manner, the cash handling system 1 in this embodiment performs the loading process from the cash accounting apparatus 21 to the cash settlement apparatus 11 and the collection process from the cash settlement apparatus 11 to the cash accounting apparatus 21, through the cash transport cassette 30. While the cash transport cassette 30 is attached to the cash settlement apparatus 11 or the cash accounting apparatus 21, cash can be passed between the cash transport cassette 30 and the cash settlement apparatus 11 or between the cash transport cassette 30 and the cash accounting apparatus 21. On the other hand, while the cash transport cassette 30 is detached from the cash settlement apparatus 11 or the cash accounting apparatus 21, the cash transport cassette 30 stores cash such that the cash therein cannot be touched. Thus, even when only a clerk performs the loading process and the collection process, the loading process and the collection process can be performed safely in terms of security. That is to say, in the loading process and the collection process, management of a manger and authorization thereof can be omitted, labor of a user can be saved.

The cash transport cassette 30 is managed by the unique cassette ID information. Thus, a process of loading change fund and a collection process can be precisely performed.

### Alternative Example

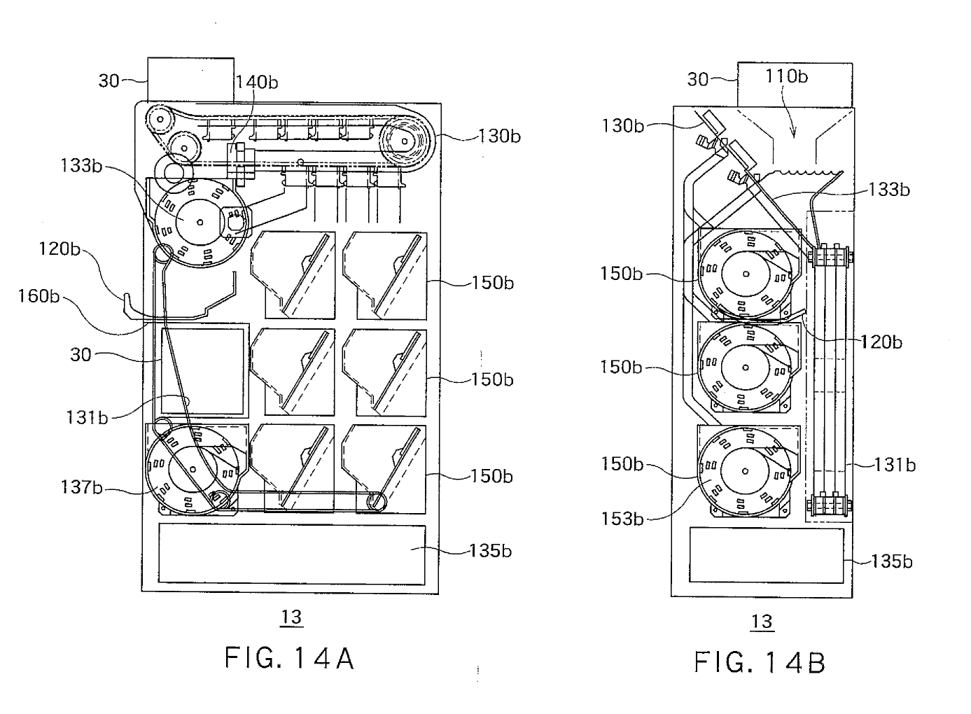

FIG. 14A and FIG. 14B are sectional views showing an example of an inside structure of the coin settlement apparatus 13 in an alternative example of this embodiment. FIG. 14A is the sectional view of the coin settlement apparatus 13 when viewed from a lateral side, and FIG. 14B is the sectional view of the coin settlement apparatus 13 when viewed from a front side.

In this alternative example, the cash transport cassette 30 is attachable to the depositing unit 110b. Upon loading process, the cash transport cassette 30 is attached to the depositing unit 110b. Upon collection process, the cash transport cassette 30 is attached to the cassette attaching unit 160b.

When the loading process is performed, the lower opening 32 of the cash transport cassette 30 is opened and a coin(s) is put into the depositing unit 110b. Thereafter, similarly to a case when loose coins are inputted by a clerk, the inputted coins are stored by denomination into the storing units 150b.

When the collection process is performed, the upper opening 31 of the cash transport cassette 30 is opened, and a coin(s) is put into the cash transport cassette 30.

In this manner, even when the cash transport cassette 30 is attached to the depositing unit 110b, upon loading process, the effect of the present invention is not lost.

1. A cash handling system comprising:
a cash settlement apparatus configured to perform a settlement process with respect to a customer, by depositing and dispensing cash;
a cash accounting apparatus configured to dispense cash to be loaded to the cash settlement apparatus, and configured to deposit cash having been collected from the cash settlement apparatus; and
a cash transport cassette attachable to and detachable from the cash settlement apparatus and the cash accounting apparatus, the cash transport cassette configured to pass cash to and from the cash settlement apparatus or the cash accounting apparatus when the cash transport cassette is attached to the cash settlement apparatus or the cash accounting apparatus, and configured to store cash such that the cash therein is incapable of being taken out when the cash transport cassette is detached from the cash settlement apparatus and the cash accounting apparatus.

2. The cash handling system according to claim 1, wherein:
the cash settlement apparatus includes a coin settlement apparatus configured to perform the settlement process by depositing and dispensing a coin, and a banknote settlement apparatus configured to perform the settlement process by depositing and dispensing a banknote; and
the cash accounting apparatus includes a coin accounting apparatus configured to dispense a coin to be loaded to the coin settlement apparatus and configured to deposit a coin having been collected from the coin settlement apparatus, and a banknote accounting apparatus configured to dispense a banknote to be loaded to the banknote settlement apparatus and configured to deposit a banknote having been collected from the banknote settlement apparatus.

3. The cash handling system according to claim 2, wherein
the cash transport cassette includes at least one of a coin transport cassette configured to pass a coin to and from the coin settlement apparatus or the coin accounting apparatus when the coin transport cassette is attached to the coin settlement apparatus or the coin accounting apparatus, and a banknote transport cassette configured to pass a banknote to and from the banknote settlement apparatus or the banknote accounting apparatus when the banknote transport cassette is attached to the banknote settlement apparatus or the banknote accounting apparatus.

4. The cash handling system according to claim 1, wherein
the cash accounting apparatus includes a depositing unit configured to deposit cash without using the cash transport cassette, and a dispensing unit configured to dispense cash without using the cash transport cassette.

5. The cash handling system according to claim 2, further comprising a storing drawer configured to store cash that is passed in the settlement process,
wherein the coin accounting apparatus includes a coin depositing unit configured to deposit a coin from the storing drawer for collection, a storing-drawer attaching unit to which the storing drawer is attachable, and a coin dispensing unit configured to dispense a coin in order to load the coin to the storing drawer attached to the storing-drawer attaching unit, after the coin has been sorted by denomination.

6. The cash handling system according to claim 1, wherein
the cash transport cassette includes a memory unit configured to store at least cassette ID information for specifying the cash transport cassette.

7. The cash handling system according to claim 6, wherein
the memory unit is configured to store denomination information of cash stored in the cash transport cassette and amount information thereof.

8. The cash handling system according to claim 6, wherein:
the cash transport cassette includes a tape reeling-type storing unit, in which respective banknotes sandwiched between a pair of elongate tapes are reeled up together with the tapes; and
the memory unit is configured to store denominations of the banknotes in the tape reeling-type storing unit in a reeled order.

9. The cash handling system according to claim 8, wherein
the cash settlement apparatus or the cash accounting apparatus is configured to store, by denomination, the banknotes from the cash transport cassette in accordance with the reeled order stored in the memory unit.

10. The cash handling system according to claim 1, further comprising a management apparatus communicably connected to the cash settlement apparatus and the cash accounting apparatus, the management apparatus configured to manage cash having been subjected to the settlement process in the cash settlement apparatus and cash having been passed between the cash settlement apparatus and the cash accounting apparatus.

11. The cash handling system according to claim 10, wherein
the management apparatus is capable of setting a denomination of cash to be collected from the cash settlement apparatus to the cash transport cassette.

12. A cash settlement apparatus configured to perform a settlement process with respect to a customer, by depositing and dispensing cash, the cash settlement apparatus comprising:
a transport unit configured to transport cash to be deposited or dispensed;
a storing unit configured to store cash having been transported by the transport unit; and
an attaching unit to which a cash transport cassette is attachable and from which the cash transport cassette is detachable, the cash transport cassette configured to pass cash to and from the cash settlement apparatus when the cash transport cassette is attached to the cash settlement apparatus, and configured to store cash such that the cash therein is incapable of being taken out when the cash transport cassette is detached from the cash settlement apparatus;
wherein when the cash transport cassette is attached to the attaching unit, the cash settlement apparatus is configured to deposit cash in the cash transport cassette to the storing unit for loading, and configured to dispense cash from the storing unit to the cash transport cassette for collection.

13. The cash settlement apparatus according to claim 12, comprising:
a coin settlement apparatus configured to perform the settlement process by depositing and dispensing a coin; and
a banknote settlement apparatus configured to perform the settlement process by depositing and dispensing a banknote.

14. The cash settlement apparatus according to claim 12, further comprising a reading/writing unit configured to read out cassette ID information from a memory unit disposed on the cash transport cassette and configured to store at least the cassette ID information for specifying the cash transport cassette;
wherein:
the memory unit is configured to store denomination information of cash stored in the cash transport cassette and amount information thereof; and
the reading/writing unit is configured to read out the denomination information and the amount information from the memory unit, or configured to write the denomination information and the amount information to the memory unit.

15. A cash accounting apparatus communicably connected to a cash settlement apparatus configured to perform a settlement process with respect to a customer by depositing and dispensing cash, the cash accounting apparatus configured to dispense cash to be loaded to the cash settlement apparatus and configured to deposit cash having been collected from the cash settlement apparatus, the cash accounting apparatus comprising:
a transport unit configured to transport cash to be deposited or dispensed;
a storing unit configured to store cash having been transported by the transport unit; and
an attaching unit to which a cash transport cassette is attachable and from which the cash transport cassette is detachable, the cash transport cassette configured to pass cash to and from the cash accounting apparatus when the cash transport cassette is attached to the cash accounting apparatus, and configured to store cash such that the cash therein is incapable of being taken out when the cash transport cassette is detached from the cash accounting apparatus;
wherein when the cash transport cassette is attached to the attaching unit, the cash accounting apparatus is configured to dispense cash to the cash transport cassette for loading the cash to the cash settlement apparatus, or configured to deposit cash from the cash transport cassette for collecting cash from the cash settlement apparatus.

16. The cash accounting apparatus according to claim 15, comprising a coin accounting apparatus configured to dispense a coin to be loaded to a coin settlement apparatus and configured to deposit a coin having been collected from the coin settlement apparatus, and a banknote accounting apparatus configured to dispense a banknote to be loaded to a banknote settlement apparatus and configured to deposit a banknote having been collected from the banknote settlement apparatus.

17. The cash accounting apparatus according to claim 15, further comprising a depositing unit configured to deposit cash without using the cash transport cassette, and a dispensing unit configured to dispense cash without using the cash transport cassette, wherein
the cash settlement apparatus includes a storing drawer configured to store cash that is passed in the settlement process, and
the coin accounting apparatus further includes a coin depositing unit configured to deposit a coin from the storing drawer for collection, and a coin dispensing unit configured to dispense a coin for loading the coin to the storing drawer.

18. A method for handling cash between a cash settlement apparatus and a cash accounting apparatus, the cash settlement apparatus configured to perform a settlement process with respect to a customer by depositing and dispensing cash, and the cash accounting apparatus configured to dispense cash to be loaded to the cash settlement apparatus and configured to deposit cash having been collected from the cash settlement apparatus, the method comprising:
in a case where cash is loaded from the cash accounting apparatus to the cash settlement apparatus,
attaching a cash transport cassette to the cash accounting apparatus, the cash transport cassette being attachable to and detachable from the cash settlement apparatus and the cash accounting apparatus;
dispensing cash to the cash transport cassette from the cash accounting apparatus;
after having detached the cash transport cassette from the cash accounting apparatus and having attached the cash transport cassette to the cash settlement apparatus, depositing the cash to the cash settlement apparatus from the cash transport cassette; and
in a case where cash is collected from the cash settlement apparatus to the cash accounting apparatus,
attaching the cash transport cassette on the cash settlement apparatus,
dispensing cash from the cash settlement apparatus to the cash transport cassette, and
after having detached the cash transport cassette from the cash settlement apparatus and having attached the cash transport cassette to the cash accounting apparatus, depositing the cash to the cash accounting apparatus from the cash transport cassette.

19. The method according to claim 18, wherein:
the cash settlement apparatus includes a coin settlement apparatus configured to perform the settlement process by depositing and dispensing a coin, and a banknote settlement apparatus configured to perform the settlement process by depositing and dispensing a banknote;
the cash accounting apparatus includes a coin accounting apparatus configured to dispense a coin to be loaded to the coin settlement apparatus and configured to deposit a coin having been collected from the coin settlement apparatus, and a banknote accounting apparatus configured to dispense a banknote to be loaded to the banknote settlement apparatus and configured to deposit a banknote having been collected from the banknote settlement apparatus;
when the cash transport cassette is attached to the coin settlement apparatus or the coin accounting apparatus, the cash transport cassette is configured to pass a coin to and from the coin settlement apparatus or the coin accounting apparatus; and
when the cash transport cassette is attached to the banknote settlement apparatus or the banknote accounting apparatus, the cash transport cassette is configured to pass a banknote to and from the banknote settlement apparatus or the banknote accounting apparatus.

20. The method according to claim 18, wherein:
the cash transport cassette includes a memory unit configured to store at least cassette ID information for specifying the cash transport cassette;
in a case where cash is loaded from the cash accounting apparatus to the cash settlement apparatus,
reading out the cassette ID information by the cash accounting apparatus while the cash transport cassette is attached to the cash accounting apparatus, and transmitting the cassette ID information to the cash settlement apparatus,
reading out the cassette ID information from the memory unit by the cash settlement apparatus, when the cash transport cassette is attached to the cash settlement apparatus, and
depositing cash from the cash transport cassette to the cash settlement apparatus, when the cassette ID information having been read out from the memory unit and the cassette ID information having been transmitted from the cash accounting apparatus conform to each other; and
in a case where cash is collected from the cash settlement apparatus to the cash accounting apparatus,
reading out the cassette ID information by the cash settlement apparatus while the cash transport cassette is attached to the cash settlement apparatus, and transmitting the cassette ID information to the cash accounting apparatus,
reading out the cassette ID information from the memory unit by the cash accounting apparatus, when the cash transport cassette is attached to the cash accounting apparatus, and
depositing cash from the cash transport cassette to the cash accounting apparatus, when the cassette ID information having been read out from the memory unit and the cassette ID information having been transmitted from the cash settlement apparatus conform to each other.

21. The method according to claim 20, wherein:
the memory unit stores denomination information of cash stored in the cash transport cassette and amount information thereof;
in a case where cash is loaded from the cash accounting apparatus to the cash settlement apparatus,
transmitting the denomination information and the amount information, together with the cassette ID information, from the cash accounting apparatus to the cash settlement apparatus,
depositing cash from the cash transport cassette to the cash settlement apparatus, when the cassette ID information having been read out from the memory unit and the cassette ID information having been transmitted from cash accounting apparatus conform to each other,
counting the deposited cash by denomination in the cash settlement apparatus, and
loading the cash to the cash settlement apparatus, when the denomination and the amount of the deposited cash respectively conform to the denomination information and the amount information; and
in a case where cash is collected from the cash settlement apparatus to the cash accounting apparatus,
transmitting the denomination information and the amount information, together with the cassette ID information, from the cash settlement apparatus to the cash accounting apparatus,
depositing cash from the cash transport cassette to the cash accounting apparatus, when the cassette ID information having been read out from the memory unit and the cassette ID information having been transmitted from the cash settlement apparatus conform to each other,
counting the deposited cash by denomination in the cash accounting apparatus, and
collecting the cash to the cash accounting apparatus, when the denomination and the amount of the deposited cash respectively conform to the denomination information and the amount information.
